(19) United States
(12) Patent Application Publication
(10) Pub. No.: US 2009/0265403 A1
(43) Pub. Date: Oct. 22, 2009

(54) FILE SYSTEM

(76) Inventor: Keiji Fukumoto, Chiba (JP)

Correspondence Address: BIRCH STEWART KOLASCH & BIRCH, PO BOX 747, FALLS CHURCH, VA, 22040-0747, US

(21) Appl. No.: 12/439,429

(22) PCT Filed: Aug. 20, 2007
(86) PCT No.: PCT/JP2007/066113

§ 371 Date: Feb. 27, 2009

(30) Foreign Application Priority Data
Aug. 31, 2006 (JP) 2006-234738
Aug. 31, 2006 (JP) 2006-234776
Aug. 31, 2006 (JP) 2006-234886

(51) Int. Cl. G06F 17/30; G06F 12/00

(52) U.S. Cl. 707/206; 711/154; 711/E12.001; 707/E17.005

(57) ABSTRACT

At step S1, file reconfiguration starts. At step S2, a block is fetched, and at step S3, a determination is made as to whether or not the fetched block is a valid block. If the block is not a valid block (NO), the process proceeds to step S8. If the block is a valid block (YES), the process proceeds to step S4, at which block information is read in. At step S5, a determination is made as to whether or not the file ID written in the read block information is a new file ID. If the file ID is a new file ID (YES), the file ID is registered at step S6, and the process proceeds to step S7. If the file ID is not a new file ID (NO), the process likewise proceeds to step S7, at which this block is added to the corresponding file ID. Then, at step S8, a determination is made as to whether or not the processing of all blocks is completed. If the processing of all blocks is not completed (NO), the process returns to step S2. If the processing of all blocks is completed (YES), the generation processing for the file configuration information is terminated. These information items are registered in a file configuration information storage area of RAM. At step S9, the information registered in the file configuration information storage area of the RAM is read out, and the file ID is taken out. A determination is made as to whether or not all blocks are present in the file having this file ID (at step S10). If all blocks are present (YES), the process proceeds to step S11, at which the file configuration information of the corresponding file ID is validated. Then, or also when all blocks are not present (NO), the process proceeds to step S12, at which a determination is made as to whether or not the processing of all file IDs is completed. If the processing of all file IDs is not completed (NO), the process returns to step S9, and the same processing is repeated. If the processing of all file IDs is completed (YES), the file reconfiguration is completed at step S13. This enables providing a file system capable of executing a high-speed initialization processing.

### TECHNICAL FIELD

The present invention relates to technology of file systems and more particularly to technology of file systems for NAND type flash memory.

### BACKGROUND ART

Recently, development in information equipments has led to attention being given to flash memory as an information recording medium for the information equipments. The reasons are that the flash memory enables miniaturization, that the flash memory does not need a drive unit and thus increases reliability, and so on. A NAND type flash memory, the capacity of which can be made large easily, in particular, is becoming rapidly widespread as the information recording medium. The NAND type flash memory is a type of flash memory and has a feature of being capable of high-speed erasing and writing.

Generally, the writing of data to the flash memory requires erasing prior to the writing. The NAND type flash memory includes plural blocks, and each of the blocks includes plural pages. The erasing takes place block by block, while the writing takes place page by page. Also, the page is generally used being divided into a portion in which data is stored and a portion in which redundant data such as an error-correcting code is stored.

FIG. 22 is a conceptual illustration of a file system for a magnetic storage. In the magnetic storage, physical reading and writing take place sector by sector. Also, logical reading and writing take place cluster by cluster (incidentally, the cluster includes a group of plural sectors).

The clusters are divided into a system area and a data area, and a file is dividedly retained in plural clusters allocated to the data area. Information about the clusters allocated to the file or information about the file itself (e.g., file configuration information) is retained in the system area. Thus, if the file is updated, this area is also rewritten. Information indicating which cluster is allocated and which cluster is unallocated is also retained in the system area. Thus, if the file is updated, this area is also rewritten.

However, the flash memory, because of its electrical characteristics, is limited in the number of times data can be erased and the number of times data can be written. Thus, a file system approach for the magnetic storage in which there is substantially no limit on the number of writes is inapplicable to the flash memory, as it is. The reason is as follows: in the case of the approach in which there is no limit on the number of writes, such file configuration information as is typified for example by FAT (file allocation table) is stored in a given location in the storage, and, if there is a change in the configuration information due to the writing of a file or the like, the contents of this location are also correspondingly updated. In short, the writing of the file leads to the updating of the file configuration information, as well as a location where the file is actually written.

FIG. 23 is a conceptual illustration of a file system for flash memory. In the flash memory, physical erasing takes place block by block, while writing takes place page by page. Logical reading and writing take place block by block (incidentally, the blocks are each composed of plural pages), and the blocks are all used as a data area. A file is dividedly retained in plural blocks. At this time, the file is retained with header information appended to the heads of the blocks. Information about the blocks allocated to the file or information about the file itself (e.g., file configuration information) is not retained in the flash memory. In other words, a file is reconfigurable with analysis of the header information of the blocks at the time of initialization of the file system, and the information itself is stored in a different memory such as a RAM (random access memory) of electronic equipment for use. Also, block utilization information indicating which block is allocated and which block is unallocated (or reallocatable) is not retained in the flash memory, either. Instead, the information is detectable with analysis of the header information of the blocks at the time of initialization of the file system, and the information itself is stored in the RAM.

The reason is as follows: if the same file system approach as that for the magnetic storage is applied to the flash memory, a given block alone undergoes frequent updating, and thus, the block becomes unusable because of immediately exceeding the limit on the number of writes, and, as a result, the overall flash memory becomes unusable.

To avoid such a problem, a standard for memory mapping for the flash memory, called FTL (Flash Translation Layer) proposed in Patent Literature 1 given below, is in practical use. This is a virtual memory mapping system, and is a method in which a physical address for the writing of data to the flash memory is assigned to a virtual address of a block of the flash memory. In other words, the writing of data to a given virtual address is translated to the writing of data to a given physical address in the flash memory. At this time, a mapping manner from the virtual address to the physical address is changed for each writing of data to the virtual address, and thus, the writing of data to the same virtual address is translated to the writing of data to different physical addresses for every writing. This enables distributing writing throughout the entire area and thus enables reducing the number of rewrites to a given block (incidentally, the approach of distributing the writing of data to a block is called wear leveling). With the use of such a memory mapping system, the file system approach for the existing magnetic storage is applicable also to the flash memory, without modification.

On the other hand, some file systems have wear leveling introduced therein. In Linux OS (operating system), a file system called jffs2 (Journaling Flash File System version 2) has been developed by Red Hat, Inc. in the U.S. This is intended to prevent the writing of data from being centralized in a given block, thereby distribute the limit on the number of writes to the flash memory across the entire area, and thereby increase the longevity of the overall flash memory.

Non-patent Literature 1: http://sources.redhat.com/jffs2/
Patent Literature 1: U.S. Pat. No. 5,404,485

### DISCLOSURE OF THE INVENTION

### Problems to be Solved by the Invention

However, the above-mentioned jffs2 needs time for its initialization processing, because this processing requires the scanning of an area in which a file is written, and the analysis of written data, in order to check a file consistency and check for a free space. In particular if there are many files and an apparatus is powered down during the writing of the files, a problem arises that the influence of the power-down is noticeable.

The jffs2 is not suitable for example for a situation where it is required that, after power-on operation, reaction to the operation be fed back to a user as soon as possible, as in the case of consumer electronics (such as a liquid crystal television set or a recorder).

Also, at the occurrence of a power-down of the apparatus during the writing of a file, only an incomplete file in progress of writing can be restored. Such a file is often unusable from an application, because of a lack of data. Also, in the event of a power-down of the apparatus during the overwrite-updating of a file, even if the file can be restored, how far the file has been updated cannot be identified. Thus, such a file is also unusable from an application. The only way to determine the validity of the restored file is to check the contents of the file by use of the application, and this increases unnecessary processing, and also, if a determination is made that the file is not correct, the file has to be deleted. This is not suitable for a situation where a sudden power-down of the apparatus occurs, as in the case of a household electrical appliance.

Further, the FTL is a memory mapping system, and a file system must be constructed on the level higher than the FTL in order that the application can treat data as a file. This approach is general purpose; however, the addition of the function of the file system to the application requiring no complicated file system is inefficient both in terms of processing speed and in terms of memory usage. In particular, unnecessary function is generally eliminated from an application that needs to run on a limited resource, such as an embedded device.

Also, the jffs2 has been developed following the framework of the file system of Linux, and thus, it is difficult to use the jffs2 on OSs other than Linux OS. Even if the jffs2 is used on the Linux OS, the jffs2 is inefficient for the application not requiring the complicated file system and is also not suitable for the embedded device as mentioned above.

An object of the present invention is to provide a file system capable of executing a high-speed initialization processing. Another object of the present invention is to provide a file system capable of preventing a file inconsistency or a file loss even in the event of a power-down of an apparatus during file writing. Still another object of the present invention is to provide a simple file system that is light in processing load, and supports wear leveling.

### Means for Solving the Problems

According to one aspect of the present invention, there is provided a file system on a flash memory, in which a memory area is divided into plural blocks, the erasing of data written in the memory area takes place block by block, the block is divided into plural pages, and the writing of data to the memory area takes place page by page, the file system being characterized by including: a block information appending means for appending to each of the blocks block information containing at least a file ID unique in the file system, assigned to the file, and a block number indicative of block linking order in the file; and a file configuration information reconstruction means for reconstructing the file configuration information indicative of the file configuration, based on the block information. The file can be correctly reconfigured based on the block information.

The file system may include a magic number appending means for appending a magic number to both the beginning page and a page other than the beginning page of each block, when writing data to the block, a page verifying means for writing data in turn from the beginning page of each block and verifying data every time the data is written in the page, and a block check means for checking the validity of each of the blocks, based on whether or not the magic number is appended to the beginning page and the page other than the beginning page of each block.

In the file system, the block may be provided with at least first and second magic number areas before and after a data area in which data is to be written, the magic number areas each being used to write the magic number therein. An area in which the block information is to be written may be provided ahead of the first magic number area.

According to another aspect of the present invention, there is provided a file configuration information reconstruction method using the above-described file system, characterized by including the steps of: taking out a block, and reading out the block information on a valid block; and linking a block having the same file ID in the order of the block number, based on whether the file ID in the block information is the same or different. Also, there is provided a block validity determining method using the above-described file system, characterized by including the steps of: reading the first and second magic numbers, and determining the validity of data of the block, according to whether the magic number is valid or invalid, based on the read contents.

According to one aspect of the present invention, there is provided a file system on a flash memory, in which a memory area is divided into plural blocks, the erasing of data written in the memory area takes place block by block, the block is divided into plural pages, and the writing of data to the memory area takes place page by page, the file system being characterized by including: a completion flag writing means for writing a write completion flag indicative of the completion of writing, into a block in a file, at the completion of the writing of the file; and completion flag reading means for reading out the write completion flag. The write completion flag can be read to facilitate detecting an incomplete file due to a power-down during file writing. Preferably, the write completion flag is written in the beginning block in the file. The write completion flag may be written in the last page of the block.

The file system may further include a block information appending means for appending to each of the blocks block information containing at least a file ID unique in the file system, assigned to the file, and a block number indicative of block linking order in the file; and a file configuration information reconstruction means for reconstructing the file configuration information indicative of the file configuration, based on the block information.

According to another aspect of the present invention, there is provided a file system on a flash memory, in which a memory area is divided into plural blocks, the erasing of data written in the memory area takes place block by block, the block is divided into plural pages, and the writing of data to the memory area takes place page by page, the file system being characterized by including a file updating means for invalidating an old file with the same name, at the completion of the writing of a file.

According to still another aspect of the present invention, there is provided a file writing method using the above-described file system, characterized by including the step of writing a write completion flag into a block in a file, at the completion of the writing of the entire file.

Also, there is provided a file updating method, characterized by including the steps of: generating a file with the same name as that of a target file to be updated; updating the file with the same name as that of the target file; and invalidating the target file at the completion of updating.

According to one aspect of the present invention, there is provided a file system on a flash memory, in which a memory area is divided into plural blocks, the erasing of data written in the memory area takes place block by block, the block is divided into plural pages, and the writing of data to the memory area takes place page by page, the file system being characterized by including: a file ID assignment means for assigning a file ID not assigned to any file, to a file, at the time of the writing of the file; a file updating means for invalidating an old file with the same name, at the completion of the writing of the file; and a file writing order determining means for determining the file writing order based on the file ID, and the file system being characterized in that the deleting of the file is performed by newly writing a delete file indicative of deleting.

Preferably, the blocks which constitute the invalidated old file are linked to each other in an erase block list based on the file writing order, and, at the time of the writing of the file, the blocks linked in the erase block list are taken out and re-used, starting from the earliest written one based on the file writing order. Preferably, the delete file has the same file name as that of the file to be deleted. Preferably, the delete file is left at least until all blocks that constitute the file to be deleted are re-used.

The delete file contains both information about the blocks that constitute the file to be deleted, and information about the blocks that constitute the file with the same name linked to the erase block list, in the form of data.

After the writing of the delete file, a processing for erasing the blocks that constitute the file with the same name linked to the erase block list may be performed. Also, at the time of reconfiguration of the erase block list, the block that constitutes the delete file may be added to the erase block list, and the block recorded in data in the delete file may be added immediately before that block. Preferably, at the time of reconfiguration of the erase block list, the block that constitutes the delete file is added to the erase block list, and the block recorded in the data in the delete file is inserted into the erase block list in an appropriate position, based on the information.

Preferably, a value that is larger than the previously assigned highest file ID number by one is assigned as the file ID not assigned to any file.

According to another aspect of the present invention, there is provided a file deleting method using the above-described file system, the file deleting method being characterized by including the steps of: assigning a file ID not assigned to any file, to a file, at the time of the writing of the file; invalidating an old file with the same name, at the completion of the writing of the file; and determining the file writing order based on the file ID, and the file deleting method being characterized in that the deleting of the file is performed by newly writing a delete file indicative of deleting.

Preferably, the blocks which constitute the invalidated old file are linked to each other in an erase block list based on the file writing order, and, at the time of the writing of the file, the blocks linked in the erase block list are taken out and re-used, starting from the earliest written one, based on the file writing order.

Also, there is provided a file system on a memory, in which a memory area is composed of blocks, the erasing of data written in the memory area takes place block by block, each of the blocks is composed of plural pages, and the writing of data to the memory area takes place page by page, characterized by including: a completion flag writing means for writing a write completion flag indicative of the write completion, into a block in a file, at the completion of the writing of the file; and a completion flag reading means for reading out the write completion flag.

Also, there is provided a file system on a memory, in which a memory area is composed of blocks, the erasing of data written in the memory area takes place block by block, each of the blocks is composed of plural pages, and the writing of data to the memory area takes place page by page, the file system being characterized by including: a file ID assignment means for assigning a file ID not assigned to any file, to a file, at the time of the writing of the file; and a file updating means for invalidating an old file with the same name, at the completion of the writing of the file, and the file system being characterized in that the deleting of the file is performed by newly writing a delete file indicative of deleting.

### EFFECTS OF THE INVENTION

The present invention provides a file system capable of a high-speed initialization processing. Also, the present invention provides a file system capable of preventing a file inconsistency or a file loss even in the event of a power-down of an apparatus during file writing. Further, the present invention provides a simple file system that is light in processing load, and supports wear leveling.

### BRIEF DESCRIPTION OF THE DRAWINGS

FIG. 1 is a functional block diagram showing an example of a configuration of electronic equipment shown as an example of equipment to which a file system according to a first embodiment of the present invention is applicable.

FIG. 2 is an illustration showing an example of area configuration of NAND type flash memory.

FIGS. 3(A) and 3(B) are illustrations showing variations of header information.

FIG. 4 is an illustration showing an example of configuration of a block for use in the file system according to the first embodiment of the present invention.

FIG. 5 is an illustration showing an example of block configuration of blocks 1 to 6 shown as examples.

FIGS. 6(A) and 6(B) are illustrations showing an example of configuration of file configuration information and an example of configuration of a file that can be regenerated from the file configuration information, respectively.

FIGS. 7(A) and 7(B) are flowcharts showing the procedure of a processing for file configuration information reconstruction.

FIGS. 8(A) and 8(B) are an illustration showing an example of block configuration for implementing the above-mentioned approach, and an illustration showing an example of configuration of four types of blocks 1 to 4, respectively.

FIGS. 9(A) and 9(B) are an illustration showing an example of such a block configuration, and an illustration showing an example of configuration of six blocks A to F, respectively.

FIGS. 10(A) and 10(B) are an illustration showing an example of configuration of a file 1 composed of the blocks A, B and C, and an illustration showing an example of configuration of a file 2 composed of the blocks D, E and F, respectively.

FIG. 11 is an illustration showing an example of file configuration information before the writing of a file.

FIG. 12 is an illustration showing configuration information (1) during the writing of a file.

FIG. 13 is an illustration showing configuration information (2) during writing.

FIG. 14 is an illustration showing an example of configuration information immediately after the completion of the writing of a file.

FIG. 15 is an illustration showing a situation where the file 1 is invalidated and the file 2 is continuously used thereby to perform updating from the file 1 to the file 2.

FIGS. 16(A) to 16(C) are illustrations showing an example of configuration information during a file write processing.

FIGS. 17(A) to 17(C) are illustrations showing an example of block linking during the writing of a file, fitted for wear leveling, for use in the file system according to the first embodiment of the present invention.

FIGS. 18(A) and 18(B) are flowcharts showing the procedure of a processing for file configuration information reconstruction, taking into account the updating of a file.

FIGS. 19(A) to 19(C) are illustrations showing an example of configuration of a file for a file delete processing.

FIG. 20 is a flowchart showing the procedure of a processing for file configuration information reconstruction, taking into account the deleting of a file.

FIG. 21 is a flowchart showing the procedure of a processing following FIG. 20.

FIG. 22 is a conceptual illustration of a file system for a magnetic storage.

FIG. 23 is a conceptual illustration of a file system for flash memory.

FIG. 24 is a flowchart showing the procedure for the file write processing.

FIG. 25 is a flow chart showing the procedure for the file delete processing.

FIG. 26 is a flowchart showing the procedure for the file delete processing that involves the erasing of a block.

### DESCRIPTION OF SYMBOLS

A . . . electronic equipment, 1 . . . control unit (CPU (central processing unit)), 3 . . . flash memory, 5 . . . RAM (memory), 7 . . . input means, 11 . . . display means, 15 . . . data input/output means

### BEST MODES FOR CARRYING OUT THE INVENTION

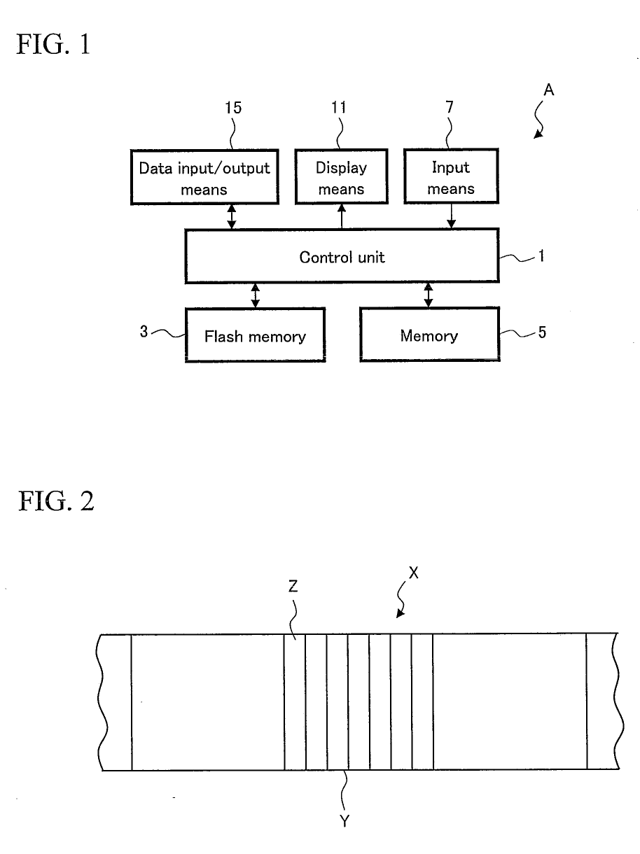

Description will be given below with reference to the drawings with regard to a file system for flash memory according to an embodiment of the present invention. FIG. 1 is a functional block diagram showing an example of a configuration of electronic equipment shown as an example of equipment to which a file system according to a first embodiment of the present invention is applicable. As shown in FIG. 1, electronic equipment A according to the first embodiment of the present invention includes a control unit (CPU) 1 that performs the entire control, nonvolatile flash memory 3 that stores a program, a data file and the like for controlling the equipment, volatile memory 5 such as RAM, a data input/output means 15 through which data is inputted and outputted, an input means 7 through which a user enters data, and a display means 11 that displays information based on a resultant output from processing input data.

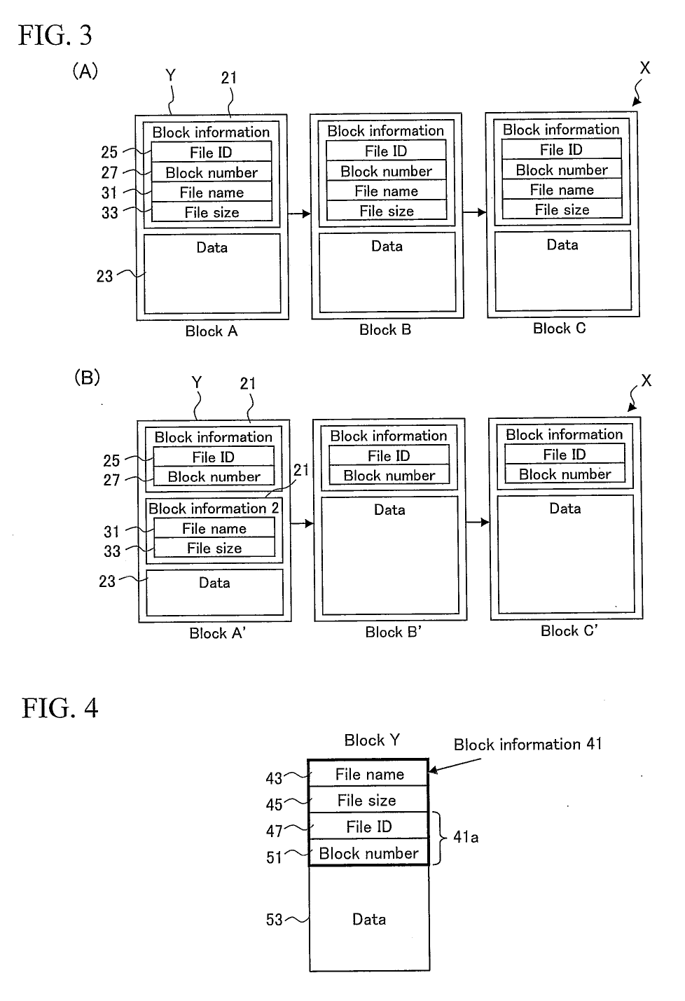

The file system for the above-mentioned electronic equipment is designed to reconfigure file configuration information on the memory 5 during a mount processing (i.e., an initialization processing for the file system), not to store the file configuration information indicating which area a file occupies in the flash memory, in a given area in the flash memory. Description will be given in detail below with regard to an example of this file system applied to NAND type flash memory. FIG. 2 is an illustration showing an example of area configuration of the NAND type flash memory. As shown in FIG. 2, a file X is composed of one or more blocks Y, and the blocks Y are each composed of pages Z. As mentioned above, the NAND type flash memory is composed of plural blocks, and the blocks are each composed of plural pages. FIGS. 3(A) and 3(B) are illustrations showing variations of block information. For example if the file X is composed of blocks A, B and C (Y), block information items 25, 27, 31 and 33 appended to data 23 may be such that the blocks A, B and C hold the same information as shown in FIG. 3(A), or may be such that the blocks A, B and C hold different information items as shown in FIG. 3(B). In an instance shown in FIG. 3(B), block information 21 formed of a file name and a file size is held only in the beginning block among the blocks composing the file (e.g., a block A′ that is the block present at the origin of the arrows of FIG. 3(B), the arrows indicating an access order).

The writing of data requires erasing prior to the writing. The erasing takes place block by block, while the writing takes place page by page. Also, the page is generally divided into a data area in which normal data is written and an OOB (out-of-band) area in which redundant data is written. The OOB area includes an area that stores an error-correcting code for correcting an error in data written in the data area, an area that indicates whether the block is a bad block, and the like.

This is due to the fact that, because of characteristics of the NAND type flash memory, erroneous data can possibly be written at the time of writing, and in this situation, the erroneous data is then read out at the time of reading of the data, and thus, there is provided an area that stores a correcting code for correction of the error. In the event of such an error as is uncorrectable with a correcting code alone, a block containing a page in which the error occurs is treated as a bad block. In the bad block, the OOB area of its beginning page has a description of the bad block. The bad blocks include an inherent bad block generated in a manufacturing process, and an acquired bad block caused by an increasing deterioration due to repetitions of erasing and writing.

Definitions of terms used in this specification will be given below.

### 1) The Term “Free Block”

The free block refers to an erased block. The free block in this condition is the block in which data can be written.

### 2) The Term “Proper Block”

The proper block refers to the block that holds data written by the file system of the present invention. The proper block can be a block constituting a file.

### 3) The Term “Invalid Block”

The invalid block refers to a block that is neither a free block nor a proper block. The invalid block is the block that requires to be erased. This block appears when a power-down occurs during the writing of data to the block, or when the file system determines that the erasing is required, and explicitly judges the block as an invalid block.

### 4) The Term “Bad Block”

The bad block refers to a physically unusable block. The bad blocks include an initial bad block, which is present since the time of shipment, and an acquired bad block, which appears while writing is repeated. In any of these bad blocks, a given portion of the OOB area is marked with bad block information, so that the bad blocks are distinguishable from a normal block. Incidentally, the above-mentioned three blocks are not bad blocks but normal blocks.

### 5) The Term “Free Block List”

The free block list refers to a list in which the free block is stored, and this list resides on the RAM.

### 6) The Term “Check Block List”

The check block list refers to a list in which the proper block is stored, and this list resides on the RAM.

### 7) The Term “Erase Block List”

The erase block list refers to a list in which the invalid block and an erasable one of the proper blocks are stored, and this list resides on the RAM.

### 8) The Term “Bad Block List”

The bad block list refers to a list in which the bad block is stored, and this list resides on the RAM.

### 9) The Term “Proper File/Proper File Candidate”

The proper file/proper file candidate refers to a file composed of a necessary and sufficient proper block and judged as the file conforming to a data structure for the file system. A file with the same name is also present. The proper file candidate refers to the file that can possibly be insufficient in part of data although it has a perfect set of blocks. The proper file forms a subset of proper file candidates.

### 10) The Term “Incomplete File”

The incomplete file refers to the file judged as an abnormal file that does not conform to the data structure for the file system. A file insufficient in constituent blocks, a file in which necessary data is not written, or the like falls under the heading of the incomplete file.

### 11) The Term “Valid File”

The valid file is one form of the proper file, and refers to the last normally written file if a file with the same name is present in the proper files. If a file with the same name is not present, the valid file refers to the file itself. However, the valid file is not a “delete-indicating file.”

### 12) The Term “Invalid File”

The invalid file refers to the file that is not a valid one of the proper files. The invalid file appears if the later file with the same name is present, or the invalid file is the “delete-indicating file.”

### 13) The Term “File ID”

The file ID refers to a unique ID in the file system, assigned to a file at the time of writing of the file. The file ID is not reassigned. For example, the next file ID to be assigned is set equal to the previously assigned highest file ID number plus one, or is otherwise set.

### 14) The Term “Block ID”

The block ID refers to a serial number for block identification.

### 15) The Term “Block Number”

The block number refers to a serial number for a block in a file.

Description will now be given with regard to the mount processing with reference to the drawings.

The file system according to the first embodiment of the present invention is characterized in that file configuration information is not recorded in a given block, and block information is appended to each block by a block information appending means and the block information is recorded in each block, and thereby, at the time of mounting, the file configuration information is constructed from the block informations by a file configuration information reconstruction means. In other words, during the mount processing, block information on all valid blocks is read in, and blocks with the same file ID are collected. Then, the file configuration information is generated from a block capable of correct file reconfiguration.

Incidentally, the block information appending means is the means for appending information about a block to the block at the time of generation of write data to the block, and generally the control unit performs this using a program; however, a dedicated hardware may append the information. In the example of block configuration shown in FIGS. 3(A) and 3(B), the blocks are shown as containing the block information already appended thereto.

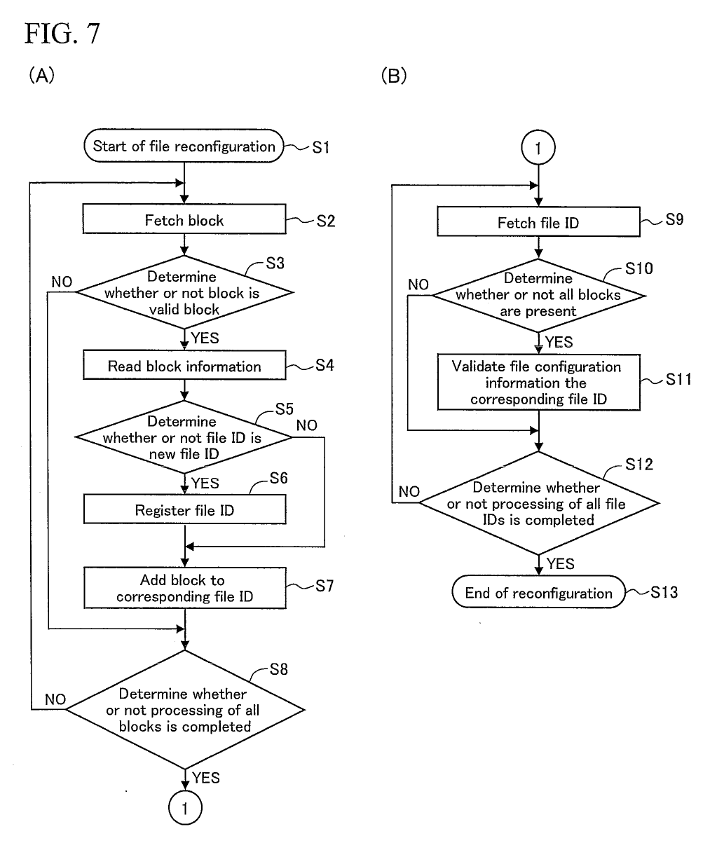

The file configuration information reconstruction means is the means for reconfiguring the file configuration information based on the above-mentioned block information at the time of mounting, and generally the control unit performs this using a program; however, a dedicated hardware may reconfigure the file configuration information. Flowcharts shown in FIGS. 7(A) and 7(B) show a program from the fetching of a block to the completion of reconfiguration. This processing corresponds to processing performed by a file reconfiguration means.

The file ID is assigned by a file ID assignment means. The file ID assignment means is the means for assigning a file ID unique in the system for file identification, at the time of writing of the file. Incidentally, the file ID is written in a block as one item of block information by the block information appending means.

At the first stage of mounting, all blocks in an area are scanned so that a determination is made as to whether each block is a free block, a proper block, an invalid block, or a bad block, and these blocks are linked to their respective lists.

More specifically, a determination is made as to whether information indicative of the bad block is recorded in the OOB area of the beginning page of each block, and, if the information is not recorded, a determination is made according to whether a predetermined magic number is written in each block. Although the magic number may be written into either the data area or the OOB area, it is necessary to read in the OOB area in order to determine whether each block is a bad block or not, and thus, the writing of the magic number in the OOB area enables simultaneous judgment and thus facilitates processing. Therefore, a determination is made according to whether the magic number is written in both the OOB areas of the beginning page and the last used page of each block. A block check means is the means for making such a determination in order to determine the validity of each block, and generally the control unit performs this using a program; however, a dedicated hardware may check the validity. In order to enable the making such a determination, at the time of writing of data to each block, the magic number and the number of pages used in the block are written in the OOB area by a magic number appending means. For the magic number appending means, generally the control unit performs this using a program; however, a dedicated hardware may perform the appending. Also, in the erased block, all bits are typically set to 1 (incidentally, the magic number is 0xffff if it is 16 bits). At this time, criteria for judgment are given in Table 1.

TABLE 1

| Bad block area in | Magic number area | Magic number area | |
|---|---|---|---|
| OOB area of | in OOB area of | in OOB area of last | |
| beginning page | beginning page | used page | Judgment |
| Normal block | All bits set to 1 | All bits set to 1 | Free block |
| | Magic number | Magic number | Proper block |

| | | |
|---|---|---|
| | Anything other than the above | Invalid block |
| Bad block | — | Bad block |

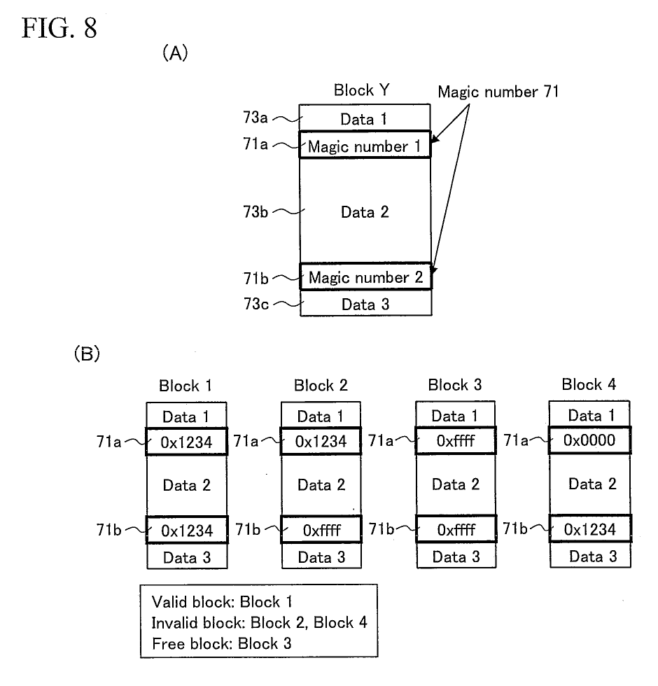

Here, a speedup in determining the validity of each block at the time of mounting can be achieved in the following manner. Description will be given with reference to FIGS. 8(A) and 8(B). An approach for the speedup can be accomplished by providing magic number areas in which the above-mentioned magic numbers are to be written, in two or more locations in each block. In other words, in order to determine the validity of each block, it is only necessary to determine whether data is correctly written or not. It takes time to read in the overall block and check for a data match, and thus, a determination can be made only by checking whether correct data is written near the beginning and near the end, provided that data is written sequentially from the beginning of the block. Therefore, the areas in which the magic numbers are written are each provided near the beginning of each block and near the end thereof. The reading of the magic numbers alone enables determining the validity of each block at high speed. Further, this facilitates determining the presence or absence of a power-down during the writing of data to the block.

FIG. 8(A) is an illustration showing an example of block configuration for implementing the above-mentioned approach. As shown in FIG. 8(A), the block Y is composed of a “data 1” area 73a, a “magic number 1” area 71a, a “data 2” area 73b, a “magic number 2” area 71b, and a “data 3” area 73c, in page order. The magic number may be contained in the data area or the OOB area, and thus, in FIG. 8(A), there is shown no distinction between the data area and the OOB area. However, it is desirable that the magic number be contained in the OOB area, and thus, it is assumed that the magic number is written in the OOB area. Also, it is assumed that the “magic number 1” area 71a is present in the beginning page of the block, and the “magic number 2” area 71b is present in a page other than the beginning of the block. Based on the criteria for judgment given in the above Table 1, a determination is made as to whether the information indicative of being a bad block is recorded in the OOB area of the beginning page of each block, and, if the information is not recorded, a determination is made as to whether the magic number is written in the OOB areas of the beginning page and the last used page of each block, thereby to check the validity of each block.

FIG. 8(B) is an illustration showing an example of configuration of four types of blocks 1 to 4. The blocks 1 to 4 are each provided with the magic number areas in which the above-mentioned magic numbers are to be written, in two or more locations, as shown in FIG. 8(A). Here, description will be given, assuming that a valid magic number is 0x1234. In the block 1, the magic numbers indicative of validity are written in the “magic number 1” area 71a and the “magic number 2” area 71b. Therefore, the block 1 can be judged as a valid block. In the block 2, the magic number indicative of validity is written in the “magic number 1” area 71a, while 0xffff is written in the “magic number 2” area 71b. It is possible that, in the block 2, a power-down has occurred during the writing of data to the block. Therefore, the block 2 can be judged as an invalid block. In the block 3, 0xffff's are written both in the “magic number 1” area 71a and in the “magic number 2” area 71b, and therefore the block 3 can be judged as a free block. In the block 4, the magic number indicative of validity is written in the “magic number 2” area 71b, while 0x0000 is written in the “magic number 1” area 71a. It is possible that the block 4 has been invalidated explicitly by the file system. Therefore, the block 4 can be judged as an invalid block.

Incidentally, the reason for making a judgment with respect to two locations, namely, the beginning page and the last used page, is that, since the writing of data to the block takes place page by page, the occurrence of a power-down during the writing of data to the block is undetectable with a check for the magic number only in one location. As for a block in which data is written only in the beginning page of the block, the beginning page and the last used page are identical, and thus, the magic number is written also in a page other than the beginning page and is used in place of the magic number of the last used page thereby to make a judgment.

Also, making a judgment on the magic numbers in two pages as mentioned above ensures that at least data in the beginning page is correct data. The reason is as follows: when data is written consecutively in plural pages in a block, data is written sequentially from the beginning page, and whether the written data is correct is verified every time the data is written in a page, and thereby, data is not written in the following page unless data is correctly written in the beginning page. In other words, even in the event of a power-down during the writing of the data 2 or the data 3, it is ensured that the data 1 preceding the magic number area 71a is valid, if the magic number areas 71a and 71b can be judged as valid. Important information may be stored in the area for the data 1 so that at least this information can be used as normal data. Incidentally, page verification is performed by a page verifying means. The page verifying means is the means for verifying whether written data is correctly written or not, at the time of the writing of the data to a page, and generally the control unit performs this using a program; however, a dedicated hardware may perform the verification.

At the second stage of mounting, the proper block in the check block list is analyzed, and the proper file candidate or the incomplete file is reconfigured. The proper block is basically to be a constituent element of the proper file candidate or the incomplete file.

Specifically, for the file reconfiguration, data having block information appended thereto, such as is given in Table 2, is written in the beginning page of each block. As mentioned above, it is ensured that the data in the beginning page of the proper block is correct, and thus, checking whether the block information is correct or not may be omitted.

TABLE 2

| Item name | Value |
|---|---|
| File ID | ID uniquely assigned by file system |
| Block number | Serial number of block in file |
| File name | User-definable file name |
| File size | Size of file |

Incidentally, the file name and the file size are not essential for the block information and may be excluded from the block information. In this case, these items may be appended to the beginning of data. (See the variations of the block information shown in FIGS. 3(A) and 3(B).)

Description will be given with reference to the drawings with regard to a more specific example of generation of file configuration information. FIG. 4 is an illustration showing an example of configuration of a block for use in the file system according to the first embodiment of the present invention. As shown in FIG. 4, the block Y includes a block information area enclosed by thick lines, and a data area 53 other than the block information area. Block information 41 contains a file name 43, a file size 45, a unique file ID 47 assigned by the file system, and a block number 51 indicative of the linking order of the block in the file. Incidentally, of these items, essential items 41a for the block information 41 are the file ID and the block number, which allow the user to obtain configuration information as to where the block belongs to.

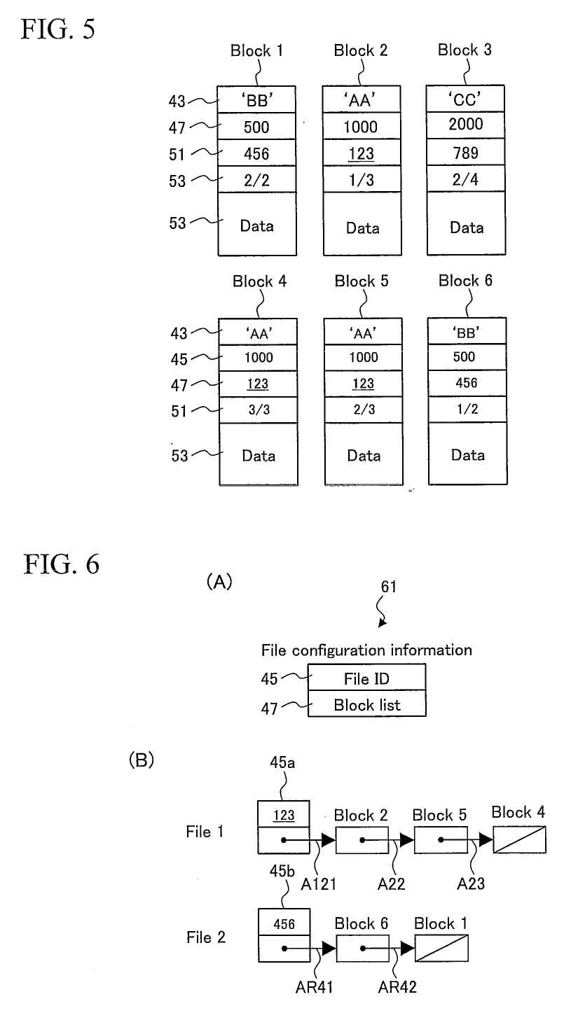

FIG. 5 is an illustration showing an example of a block configuration of blocks 1 to 6 shown as examples. In the block 1, the file ID 47 is “456,” and the block number 51 is 2/2. The number “2/2” indicates that the block 1 is the second one of two blocks. In the block 2, the file ID 47 is “123,” and the block number 51 is 1/3. In the block 3, the file ID 47 is “789,” and the block number 51 is 2/4. In the block 4, the file ID 47 is “123,” and the block number 51 is 3/3. In the block 5, the file ID 47 is “123,” and the block number 51 is 2/3. In the block 6, the file ID 47 is “456,” and the block number 51 is 1/2.

FIGS. 6(A) and 6(B) are illustrations showing an example of configuration of file configuration information and an example of configuration of a file that can be regenerated from the file configuration information, respectively. As shown in FIG. 6(A), file configuration information 61 contains a file ID 45 and a block list 57. As shown in FIG. 6(B), it can be seen that the block list of a file 1 having the file ID equal to “123” is composed of the blocks 2, 5 and 4 linked in the order indicated by arrows AR1, AR2 and AR3. On the other hand, it can be seen that a file 2 having the file ID equal to “456” is composed of the blocks 6 and 1 linked in the order indicated by arrows AR11 and AR12.

Description will now be given with reference to FIGS. 7(A) and 7(B) with regard to the procedure for file configuration information reconstruction. At step S1, file reconfiguration starts. At step S2, a block is fetched, and at step S3, the block check means is used to determine whether the fetched block is a valid block. If the block is not a valid block (NO), the process proceeds to step S8. If the block is a valid block (YES), the process proceeds to step S4, at which block information is read in. At step S5, a determination is made as to whether or not the file ID written in the read block information is a new file ID. If the file ID is a new file ID (YES), the file ID is registered at step S6, and the process proceeds to step S7. If the file ID is not a new file ID (NO), the process likewise proceeds to step S7, at which this block is added to the corresponding file ID. Then, at step S8, a determination is made as to whether or not the processing of all blocks is completed. If the processing of all blocks is not completed (NO), the process returns to step S2. If the processing of all blocks is completed (YES), the generation processing for the file configuration information is brought to an end. These information items are registered in a file configuration information storage area of the RAM. The file registered at this point is an incomplete file or a proper file candidate.

Description will now be given with regard to a processing for extracting proper file candidates from the files, based on the file configuration information. At step S9, the information registered in the file configuration information storage area of the RAM is read out, and the file ID is taken out. A determination is made as to whether or not all blocks are present in the file having this file ID (at step S10). If all blocks are present (YES), the process proceeds to step S11, at which the file configuration information of the corresponding file ID is validated. Then, or also when all blocks are not present (NO), the process proceeds to step S12, at which a determination is made as to whether or not the processing of all file IDs is completed. If the processing of all file IDs is not completed (NO), the process returns to step S9, and the same processing is repeated. If the processing of all file IDs is completed (YES), the file reconfiguration is brought to completion at step S13. Incidentally, the processing from steps S1 to S8 and the processing from steps S9 to S13 may be performed concurrently. The processing as mentioned above facilitates the generation and reconfiguration of the file configuration information. The file configuration information is not stored in the flash memory, which in turn enables avoiding the writing and reading of data to and from the same area, at the time of file reconfiguration based on the block information alone.

Incidentally, a file that is not a proper file candidate is an incomplete file. At the third stage of mounting, a valid file is selected out of the reconfigured proper file candidates. The valid file is a proper file candidate that can be a proper file. If there is no other proper file with the same name, the file itself is selected. If there are files with the same name, the last written file is selected. Also, a condition for the valid file is that the file is not a “delete-indicating file.” Incidentally, description will be given later with regard to the presence of the files with the same name, making a judgment on the last written file with the same name, and the “delete-indicating file.”

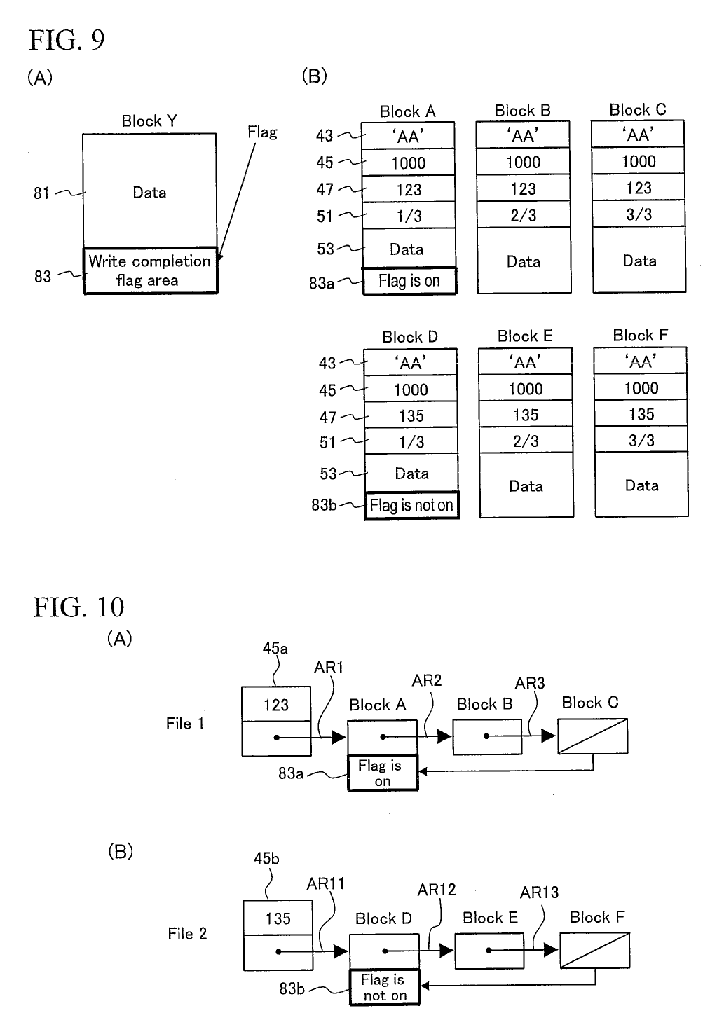

When verification is required for the writing of data to a block, the occurrence of a power-down during the verification leads to the problem of making it impossible to verify whether the data is really correctly written in the block. When a file is composed of plural blocks, the occurrence of a power-down at the last block brings about a situation where the validity of the writing of data to the last block cannot be determined and hence the contents of the file can possibly become abnormal. Therefore, the file system according to the first embodiment of the present invention is characterized in that a write completion flag is written in any given block in a file thereby to bring the writing of the file to completion. Any given block in the file is provided with an area in which the flag indicative of the completion of the writing of the entire file is to be written, and thereby, whether the writing of the file has been normally performed can be easily determined only by checking the flag. Therefore, this facilitates the detection of the incomplete file resulting from the occurrence of a power-down during the writing of the file. FIG. 9(A) is an illustration showing an example of such a block configuration. As shown in FIG. 9(A), the block Y contains a data area 81 and a write completion flag area 83. FIG. 9(B) is an illustration showing an example of configuration of six blocks A to F. The blocks A to C are the blocks contained in the file 1, and the blocks D to F are the blocks contained in the file 2. Here, the last page of the beginning block of each of the files 1 and 2 is provided with a write completion flag area 83a in which the write completion flag indicative of the completion of writing is to be written. Preferably, the write completion flag area is contained in the beginning block although the area may be provided anywhere. As shown in FIG. 10(A), in the file 1 composed of the blocks A, B and C, normal writing is performed to the block C that is the last block, and the description “the flag is on” is given in the write completion flag area 83a at the last page of the block A, and thus, it can be seen that the writing of the file has been performed normally. On the other hand, as shown in FIG. 10(B), in the file 2 composed of the blocks D, E and F, the flag is not written in a write completion flag area 83b provided in the last page of the block D, and thus, a determination can be made that the writing of the file is incomplete. In other words, the file system is characterized in that, of blocks that constitute a file, the beginning block of the file is provided with the area 83 in which data (i.e., the write completion flag) indicative of the completion of the writing of the blocks of the entire file is to be written, in order to determine whether or not the proper file candidate is a proper file.

One example of mounting is that the last page of the beginning block is not used for the writing of data of a file but used for the writing of the write completion flag. Thereby, whether the write completion flag is written in a block at the beginning of a given file can be checked to determine whether or not all blocks of a file having that block as the beginning block are normally written. The proper file candidate having the write completion flag written therein is judged as a proper file. Incidentally, the write completion flag is written by a completion flag writing means after the completion of the writing of a file. Also, at the time of mounting, the write completion flag is read by a completion flag reading means and is used to determine whether the writing of a file is completed. Although the control unit generally performs writing and reading and makes a judgment with use of a program, a dedicated hardware may perform these operations.

A block that constitutes the valid file is removed from the check block list. A block that is not the block that constitutes the valid file is removed from the check block list and is linked to the erase block list. In other words, these blocks are the blocks that constitute the invalid file and the incomplete file. These blocks are reallocatable. Incidentally, blocks are linked to the erase block list in the order in which data has been written to the blocks.

A series of processings mentioned above leads to the linking of a free block to the free block list and the linking of a block to be erased or an erasable block to the erase block list, after the completion of mounting.

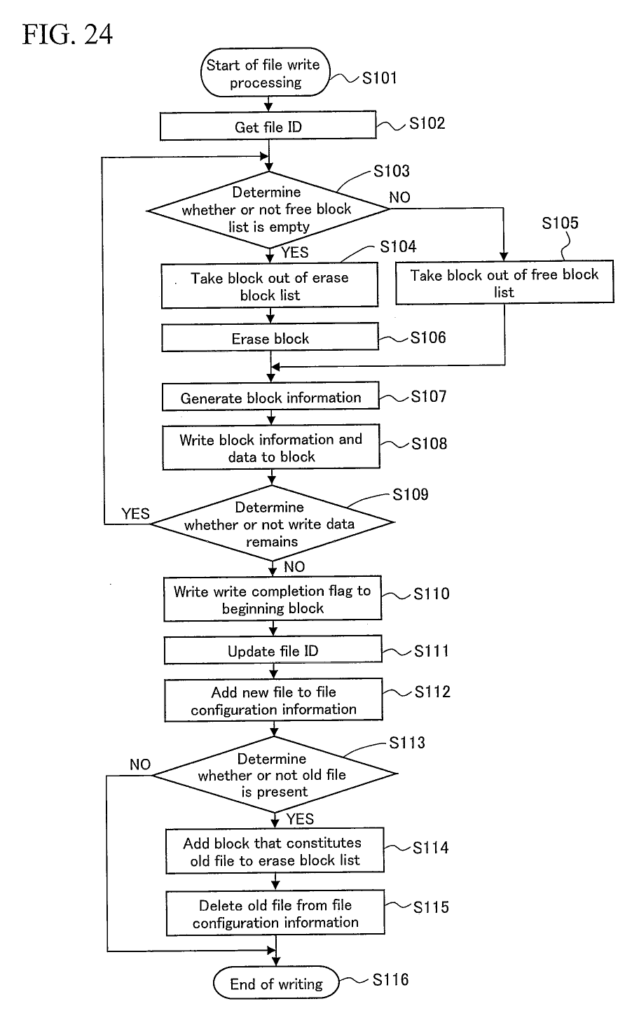

Description will now be given with reference to FIG. 24 with regard to a file write processing. First, the write processing starts at step S101. Then, at step S102, the file ID assignment means is used to get a file ID. At step S103, a determination is made as to whether or not the free block list is empty. If the free block list is empty (YES), the process proceeds to step S104, at which a block is taken out of the erase block list, not the free block list. At step S106, the block is erased, and at step S107, block information is generated. If the free block list is not empty at step S103 (NO), the process proceeds to step S105, at which a block is taken out of the free block list. The process proceeds to step S107, at which block information is generated.

Then, at step S108, the block information and data are written to the block, and at step S109, a determination is made as to whether or not write data remains. Then, at step S110, the completion flag writing means is used to write a write completion flag to the beginning block. At step S111, the file ID is updated (that is, information indicative of the use of the file ID is given to the file ID assignment means), and at step S112, a new file is added to file configuration information. At step S113, a determination is made as to whether or not an old file is present. If the old file is present (YES), the process proceeds to step S114, at which a block that constitutes the old file is added to the erase block list. At step S115, the old file is deleted from the file configuration information, and the writing is brought to an end (at step S116). If the old file is absent, the processing is brought to an end (at step S116). Here, steps S110 to S115 indicate a procedure of a file updating means to be described later. In other words, this processing is as follows: if there is an old file with the same name as that of the completely written file, the old file is invalidated, and also, the new file is validated. If the old file is absent, the processing is merely to validate the new file. Although the control unit generally performs the processing from steps S110 to S115 with use of a program, a dedicated hardware may perform the processing.

As described above, a block to be used for the writing of a file is taken out of the free block list. If the free block list contains no block, a block is taken out of the erase block list, the block is erased, the block is placed into the free block list, and thereafter, the block is taken out of the free block list. With such a procedure, a block in the erase block list is reused only after blocks in the free block list have been used up, and thus, the reuse of a block does not take place between the initialization of the entire area and the writing of data to blocks of the entire area. Also, blocks linked to the erase block list are linked in the order in which they have been written, and, also when being linked, the blocks are linked in the order in which they have been written. Therefore, a situation does not arise where a given block in the erase block list is reused many times.

In the above step S110, at the time when the write completion flag is written to the beginning block of the file, the writing of the file is performed normally. In other words, in the event of a power-down before step S110, the written block is a block that constitutes an incomplete file, or an invalid block, and, in the next mount processing, the block is linked to the erase block list. At this time, even the incomplete file is assigned with the file ID, and thus, this file is linked to the tail end of the erase block list. The invalid block is linked to the head of the erase block list. This is equivalent to the absence of writing.

At the occurrence of a power-down after step S110, the processing of steps S114 and S115, if necessary, is surely performed in the next mount processing, and thus, it is not required that particular consideration be given to such a situation.

Description will now be given with regard to a file update processing.

To update a file, a general file system employs the approach of directly rewriting a portion in which the file is recorded, or the approach of creating a file with a different name and then changing the file name. However, these approaches involve the risk of a data inconsistency or a file loss in the event of a power-down during rewriting or in the event of a power-down during changing the file name. On the other hand, the flash memory has to erase the entire block in order to perform rewriting, and the rewriting of only a portion is inefficient, and moreover, there is a limit on the number of rewrites. Therefore, the above-mentioned approaches are not suitable for the flash memory.

Therefore, the file system according to the first embodiment of the present invention is characterized in that the presence of a file with the same name in the file system is permitted, the last written file is handled as a valid file, and also, an old file is invalidated after the completion of the writing of a new file. This enables eliminating the above-mentioned risk resulting from the occurrence of a power-down during file updating. These processings are performed by the file updating means.

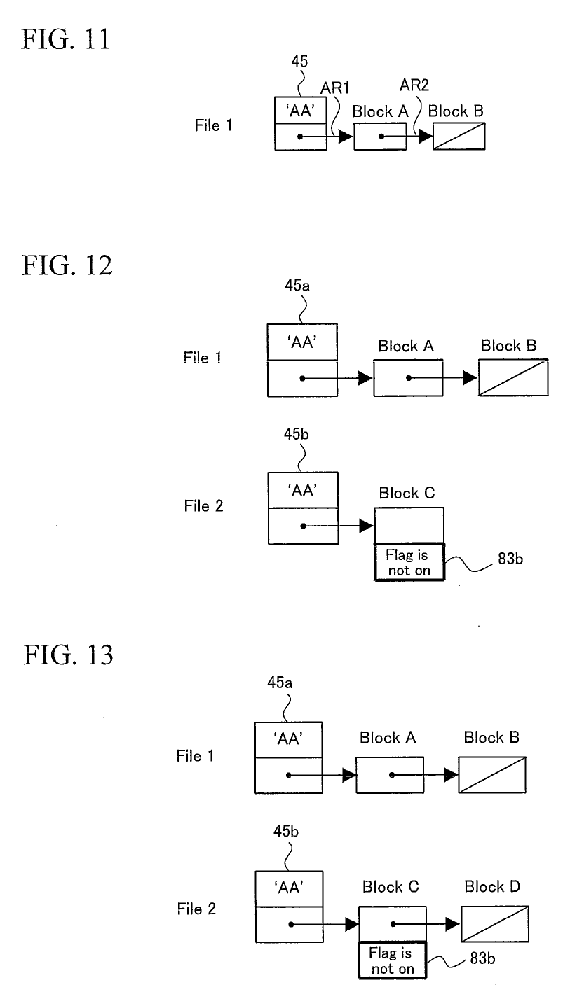

More detailed description will now be given with reference to the drawings. FIG. 11 is an illustration showing an example of file configuration information before the writing of a file. As shown in FIG. 11, in the file 1, the configuration information before the writing of the file contains the file name ‘AA,’ and the file 1 with the file name AA is composed of the block A and the block B, as indicated by the arrow AR1 and the following arrow AR2. Configuration information (1) during the writing of a file, shown in FIG. 12, is such that, for the writing of the file for the purpose of updating of the file 1, a file 2 with the same name as that of the file 1, besides the file 1, is created as shown in FIG. 12. The block C contained in the file 2 has no flag set in its flag area 83b (that is, the flag is not on), because the writing of the file is not yet completed. Configuration information (2) during the writing of the file, shown in FIG. 13, is such that, for the file 2, the blocks C and D are linked as shown in FIG. 13. In this situation, the writing of the file is not yet completed, and thus, the flag is not set in the flag area 83b.

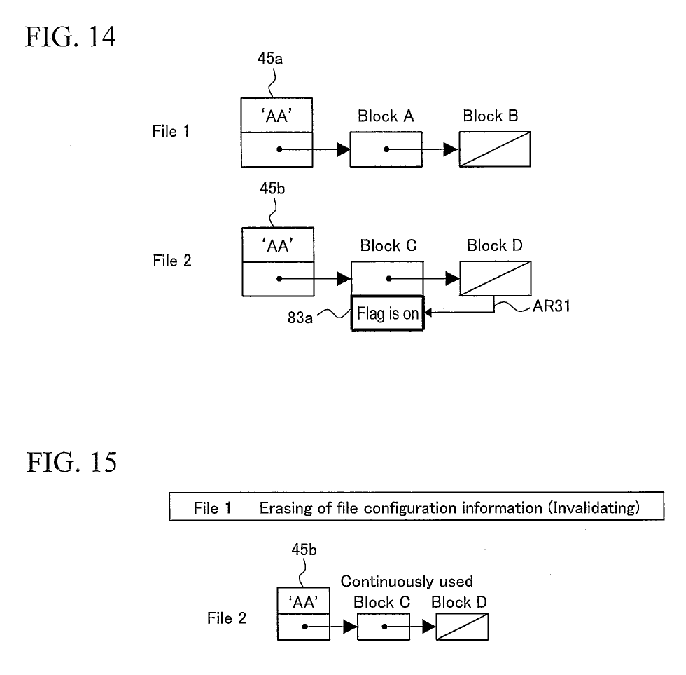

FIG. 14 is an illustration showing an example of configuration information immediately after the completion of the writing of a file. As shown in FIG. 14, in the file 2, the block D is linked, and then, the flag is set in the flag write area 83a (that is, the flag is on), as indicated by the arrow AR31. Thereafter, the flag is on, and thus, the file 2 survives even in the event of a power-down. Therefore, as shown by an example of the updating of the file configuration information, even if the file 1 is invalidated, the file 2 is consecutively used, and thereby, the updating from the file 1 to the file 2 can be performed. In this condition, the writing of the file configuration information to the RAM is performed.

As mentioned above, the presence of the files with the same name is permitted, and the updating is performed by use of files with the same name. Thereby, even in the event of a power-down during the updating, the updating of the file can be performed with safety without the risk that both the pre-update file and the post-update file are lost.

Description will now be given with regard to a file delete processing. The file system according to the first embodiment of the present invention is characterized in that the deleting of a file is accomplished by writing a “file-delete-indicating file.” For the deleting of a file, the configuration information about the file can be removed from the file configuration information; however, the file configuration information resides on the RAM, and thus, in the event of a power-down in that situation, the deleted file is restored at the next time of the mount processing. Therefore, not only the erasing of the configuration information about the file but also the erasing of a block that constitutes the file is required. However, such processing takes time, in the case of the deleting of a file composed of plural blocks or in the case of a device requiring much time for erasing. Therefore, rather than the erasing of a block that constitutes a file, the writing of a file-delete-indicating file is performed, and the file-delete-indicating file and the file deleted by the file-delete-indicating file are transparent to the user. Thereby, even in the event of a power-down, the deleted file is not restored at the next time of the mount processing. Here, for example when a file with the same name, which is zero in size, is written as the file-delete-indicating file, high-speed deleting can be accomplished only by writing at most one block of data.

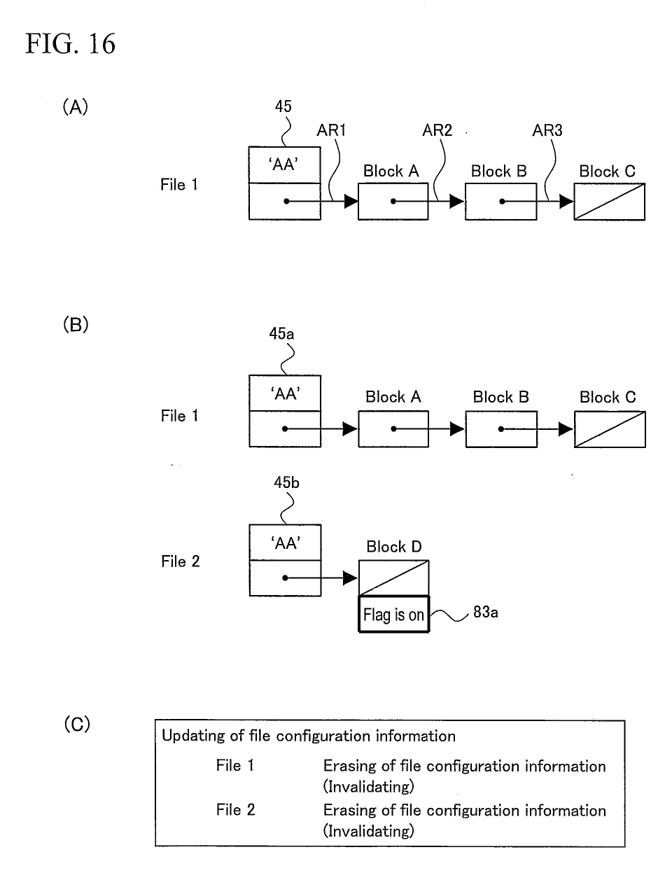

FIG. 16(A) is an illustration showing an example of configuration information before the writing of a delete-indicating file (that is, configuration information before the writing of a “file-delete file”). As shown in FIG. 16(A), it can be seen that, before the writing of the delete-indicating file, the file 1 with the file name 45, ‘AA,’ is composed of the blocks A, B and C linked in the order indicated by the arrows AR1, AR2 and AR3. Here, for the deleting of the file 1 composed of plural blocks, a file 2 containing the block D alone is generated as shown in FIG. 16(B). The file 2 is the file-delete file and is zero in size (that is, configuration information immediately after the completion of the writing of the “file-delete file”). The flag indicative of the completion of the writing is set in the flag write area 83a of the file 2. Then, the file 1 can be overwritten with the zero-size file 2 so that the file 1 is deleted in user-transparent form. In this case, when there are files with the same name ‘AA,’ the last written file 2 is valid. Specifically, as shown in FIG. 16(C), invalidation of the files 1 and 2 facilitates substantially deleting the file 1. In other words, a speedup in file deleting becomes possible.

As mentioned above, the file deleting can be accomplished by writing the “delete-indicating file.” For example, in the above description, a file with the same name, which is zero in file size, is left to act as the delete-indicating file; however, it is to be understood that this file is not specifically limited to. Note that it is preferable that the “delete-indicating file” be transparent to the user. The writing procedure is substantially the same as that of an ordinary file writing; however, after file writing, a processing of linking a block that constitutes the “delete-indicating file” to the erase block list is added.

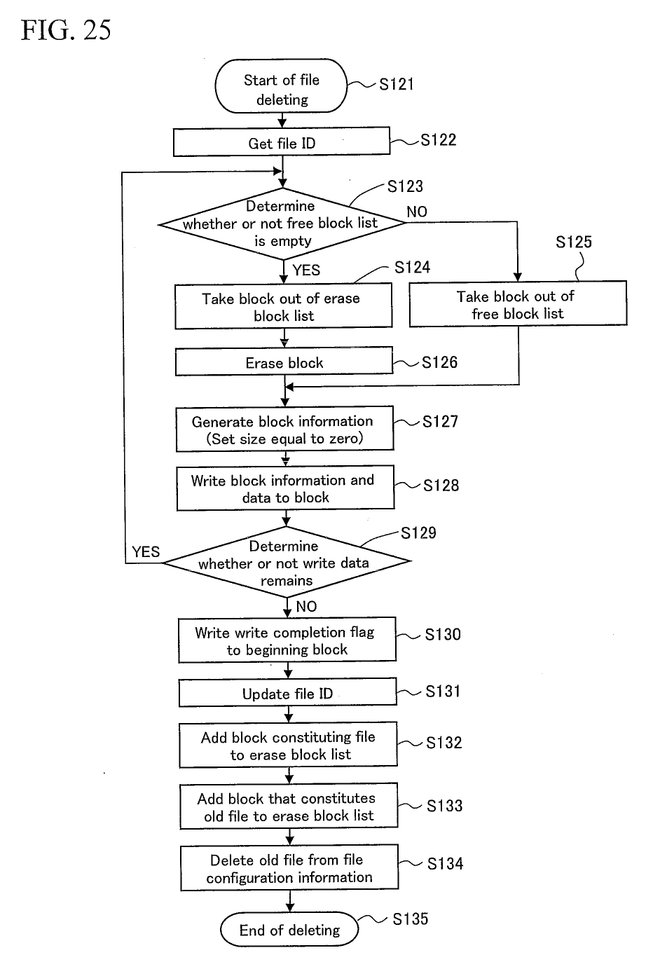

FIG. 25 shows a flowchart of the file delete processing. First, the delete processing starts at step S121. Then, at step S122, a file ID is acquired. At step S123, a determination is made as to whether or not the free block list is empty. If the free block list is empty (YES), the process proceeds to step S124, at which a block is taken out of the erase block list, not out of the free block list. At step S126, the block is erased, and at step S127, block information is generated. At this time, the file size is set equal to zero. If the free block list is not empty at step S123 (NO), the process proceeds to step S125, at which a block is taken out of the free block list. The process proceeds to step S127, at which block information is generated. At this time, the file size is set equal to zero. Then, at step S128, the block information and data are written to the block, and at step S129, a determination is made as to whether or not write data remains. Then, at step S130, a write completion flag is written to the beginning block. At step S131, the file ID is updated. At step S132, the block constituting a file is added to the erase block list. At step S133, a block constituting the old file is added to the erase block list. At step S134, the old file is deleted from the file configuration information, and the writing is brought to an end (at step S135).

Incidentally, in the above step S130, at the time when the write completion flag is written to the beginning block of the file, the writing of the file is completed normally. In other words, in the event of a power-down before step S130, the written block is a block that constitutes an incomplete file, or an invalid block, and, in the next mount processing, the block is linked to the erase block list. At this time, even the incomplete file has been assigned with the file ID, and thus, this file is linked to the tail end of the erase block list. The invalid block is linked to the head of the erase block list. This is equivalent to the absence of deleting.

Even at the occurrence of a power-down after step S130, the processing of steps S132 to S134, if necessary, is surely performed in the next mount processing, provided that the last written file is used as a valid file. Thus, it is not required that particular consideration be given to such a situation.

Description will now be given with regard to a file ID assignment method and a block re-use method.

Description has been previously given with regard to the method in which, at the time of mounting, the file is reconfigured based on the file ID assigned to the block, whereby the valid file is extracted. Also, description has been given with regard to the method in which, if there are files with the same name, the last written file is used as a valid file, whereby a defective condition is not encountered even in the event of a power-down during file writing or deleting. Further, description has been given with regard to the method in which, as for the blocks that constitute the invalid file, the blocks are re-used in the order in which the file is written to the blocks.

These methods are independent of each other; however, when the file writing order can be determined based on the unique file ID, all the methods can be satisfied at a time. In particular, the file ID is not reassigned and a new file ID is assigned every time a file is written, and further, preferably, the file ID increases monotonically or decreases monotonically.

Therefore, the file system according to the first embodiment of the present invention is characterized in that the file ID assigned by the file ID assignment means is set equal to the previously assigned highest file ID number plus one, and that there is provided a file writing order determining means for determining the file writing order based on the magnitude of the file ID.

For a method in which a block that constitutes an invalid file produced by the occurrence of a power-down during file writing or an invalid file that is unnecessary due to file updating or deletion is left as it is and such a block is re-used if a block is necessary for new writing, it is desirable to prevent a situation where a given block is re-used many times. The assignment of the file ID to the file (or the block) enables the re-use of the unnecessary old block. Mounting also follows this. Thus, this has the advantage of enabling proper block allocation at the time of block re-use. In other words, wear leveling becomes possible.

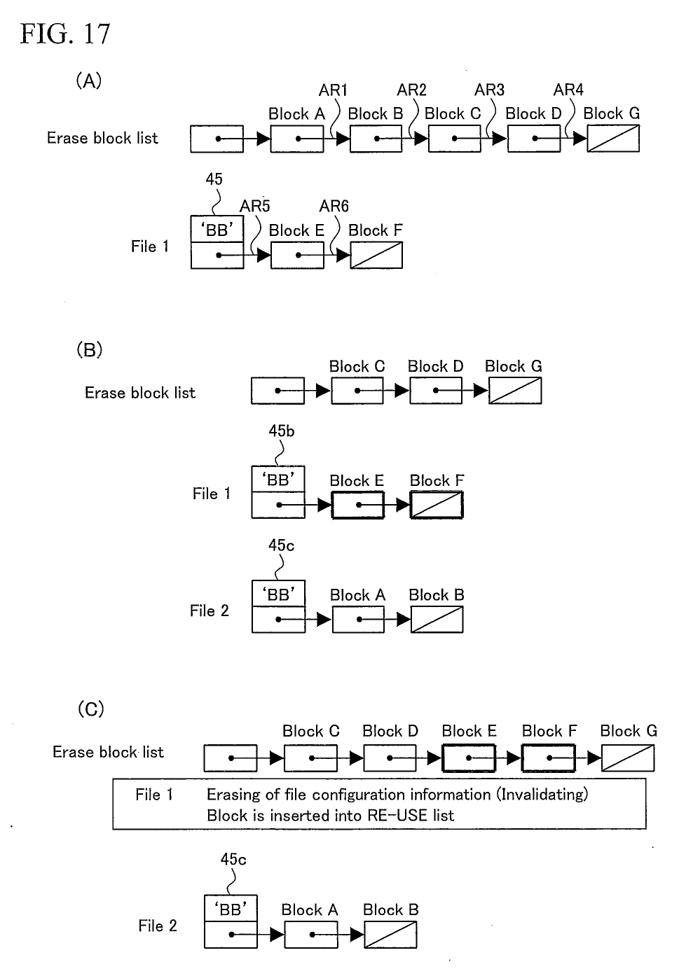

FIGS. 17(A) to 17(C) are illustrations showing an example of block linking during the writing of a file, fitted for wear leveling (that is, configuration information before the writing of the file), for use in the file system according to the first embodiment of the present invention. FIG. 17(A) is an illustration showing an example of the configuration information before the writing of the file. As shown in FIG. 17(A), the erase block list is a list where the block A (AR1), the block B (AR2), the block C (AR3), the block D (AR4) and a block G (AR4) are linked next to each other in the listed order. On the other hand, the file 1 is a file with the file name ‘BB,’ and composed of a block E (AR5) and a block F (AR6) which are linked each other in the listed order. Here, the file ID becomes larger in the direction from the block A to the block G.

FIG. 17(B) is an illustration showing an example of file configuration information immediately after the completion of the writing of a file (that is, configuration information immediately after the completion of the writing of the file). The blocks linked to the erase block list shown in FIG. 17(A) are re-used in increasing order of the magnitude of the file ID (incidentally, the file ID becomes larger in the direction from the block A to the block G). The file 1 has the same configuration as that shown in FIG. 17(A), the file 2 has the same name ‘BB’ as that of the file 1, and the block A and the block B are taken out of the erase block list and used in increasing order of the block number.

Then, the file configuration information is updated as shown in FIG. 17(C). Specifically, as for the file 1, the file information is erased (or is invalidated), and the block being contained until then in the file 1 is inserted into the erase block list (that is, the file configuration information is updated). The blocks E and F are inserted between the blocks D and G in the erase block list, based on the order of the magnitude of the file ID determined by the file writing order determining means. Then, the file 2 is composed of the blocks A and B.

Incidentally, if the file 2 is further updated, the blocks A and B's become larger in file ID than the block G, and thus, the blocks A and B are linked to the erase block list after the block G.

Description will be given again with reference to FIG. 24 with regard to the write processing. First, the write processing starts at step S101. Then, at step S102, a unique file ID is acquired. Here, the newly acquired file ID is set equal to the highest file ID number previously assigned by the file system plus one. At step S103, a determination is made as to whether or not the free block list is empty. If the free block list is empty (YES), the process proceeds to step S104, at which a block is taken out of the erase block list, not out of the free block list. At step S106, the block is erased, and at step S107, block information is generated. If the free block list is not empty at step S103 (NO), the process proceeds to step S105, at which a block is taken out of the free block list. The process proceeds to step S107, at which block information is generated.

Then, at step S108, the block information and data are written to the block, and at step S109, a determination is made as to whether or not write data remains. Then, at step S110, a write completion flag is written to the beginning block. At step S111, the file ID is updated, and information indicative of the use of the file ID is given to the file system. At step S112, a new file is added to the file configuration information. At step S113, a determination is made as to whether or not an old file is present. If the old file is present (YES), the process proceeds to step S114, at which a block that constitutes the old file is added to the erase block list. At step S115, the old file is deleted from the file configuration information, and the writing is brought to an end (at step S116). If the old file is absent, the processing is brought to an end (at step S116). As described above for the file write processing, a block to be used for the writing of a file is acquired from the free block list. If the free block list contains no block, a block is taken out of the erase block list and the block is erased, and thereafter, the block is linked to the free block list, and the block is acquired from the free block list.

This means that all blocks are linked to the free block list under a condition where the entire area of the NAND type flash memory is initialized, and a block in the erase block list is reused only after the blocks have been used up. Also, the blocks in the erase block list are linked in the order of the file ID. The blocks with the same file ID are linked in the order of the block number. In other words, the block to be re-used is the earliest written one of erasable blocks.

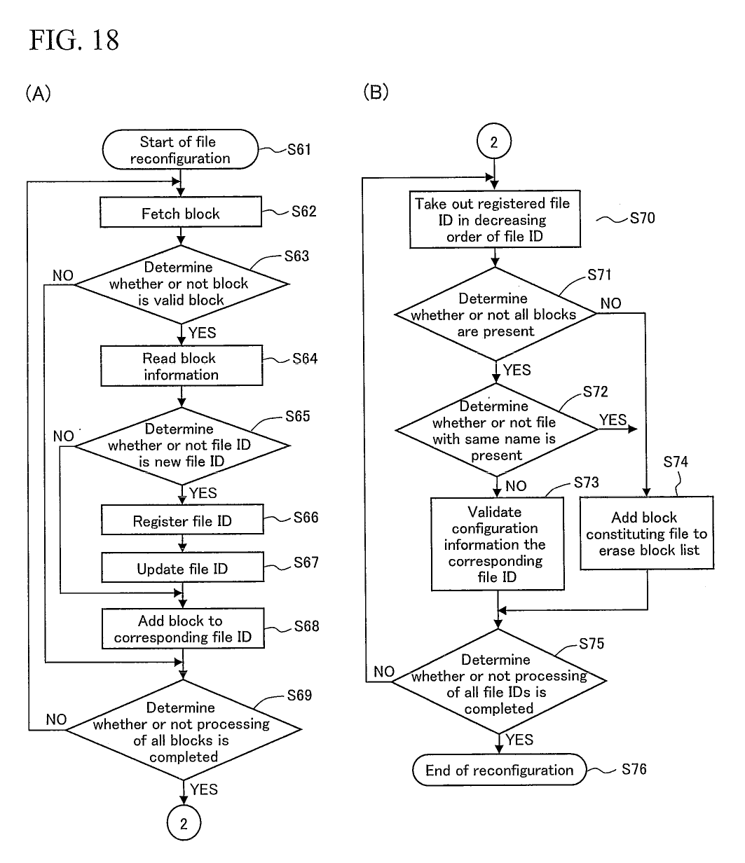

Description will now be given with reference to FIGS. 18(A) and 18(B) with regard to the procedure of the mount processing. At step S61, a file reconfiguration processing starts. Then, at step S62, a block is fetched, and at step S63, a determination is made as to whether or not the fetched block is a valid block. If the block is not valid (NO), the process proceeds to step S69. If the block is valid (YES), block information is read in at step S64. At step S65, a determination is made as to whether or not the file ID in the block information is a new file ID. If the file ID is not a new file ID (NO), the process proceeds to step S68. If the file ID is a new file ID (YES), the file ID is registered at step S66, the file ID is updated at step S67, and the process proceeds to step S68. At step S68, the fetched block is added to the corresponding file ID.

At step S69, a determination is made as to whether the processing of all blocks is completed. If the processing of all blocks is not completed (NO), the process returns to step S62. If the processing of all blocks is completed (YES), the process proceeds to step S70, at which the registered file ID is taken out in decreasing order of the file ID. In other words, at step S70, the file writing order determining means is used to extract the files sequentially from the last written file, and the following processing is continued. At step S71, a determination is made as to whether or not all blocks are present. If all blocks are present (YES), the process proceeds to step S72, at which a determination is made as to whether or not a file with the same name is present. Then, at step S73, the file configuration information of the corresponding file ID is validated, and the process proceeds to step S75. If all blocks are not present (NO), the process proceeds to step S74, at which blocks constituting the file are inserted into the erase block list in the order of the file ID. The process proceeds to step S75. At step S75, a determination is made as to whether or not the processing of all file IDs is completed. If the processing of all file IDs is not completed (NO), the process returns to step S70. If the processing of all file IDs is completed (YES), the reconfiguration is brought to completion at step S76.

Thereby, in the event of a power-down during file writing, the block used for the file writing is linked to the end of the erase block list at the next time of the mount processing. The reason is as follows: the blocks in the erase block list are linked in the order of the file ID, and the file ID used for the last writing which has encountered the power-down is the largest at that time. This means that that block is reused only after the blocks being in the erase block list at the time of the file writing have been used up. In other words, this enables preventing a situation where a given block alone is re-used many times.

Since until now no particular mention has been made of the handling of the bad block, brief description thereof will now be given.

In the NAND type flash memory, the bad blocks include an initial bad block present since the time of shipment, and an acquired bad block that appears due to the occurrence of wear while erasing or writing is repeated. These are the blocks from which data can possibly be incorrectly read, and the use of those blocks need to be avoided. In such a block, information indicating that the block is a bad block is recorded in the OOB area. Such bad blocks are detectable at the time of the mount processing, and thus, these blocks may be placed in the bad block list so that the use of those blocks is avoided.

The initial bad block has the information indicative of the bad block recorded therein at the time of shipment; however, the acquired bad block must be detected and recorded at the time of writing. Specifically, after the writing of data to the block, the same block may be read again for verification. At this time, the block in which an error is found in the verification although the writing and reading is normally performed is an acquired bad block. For such a block, the information indicative of the bad block is recorded in the OOB area of the beginning page, and the block is placed in the bad block list, and also, the block is not used thereafter. Once the information indicative of the bad block is recorded in the OOB area, the bad block is detectable even at the time of the mount processing after the occurrence of a power-down, and thus, the bad block is not used.

As described above, the file system according to the first embodiment of the present invention enables high-speed file processing. Also, the file system enables wear leveling. Further, the file system has the advantage of making it possible to reconfigure file information and thus preventing a file from being damaged or destroyed, even in the event of a power-down during file writing.

Description will now be given with regard to a file system according to a second embodiment of the present invention. In the first embodiment, file deleting is accomplished by writing the “delete-indicating file.” However, there may be a demand that data be actually physically erased from a standpoint of security.

In this case, there exists a method for the deleting of a file, which involves actually erasing blocks used by the file, rather than writing a “delete-indicating file.” However, in the event of a power-down after the erasing of the blocks, these blocks are treated as free blocks at the time of the mount processing of the file system at the next power-on, and thus, the blocks are soon re-used. Further, in the event of a power-down after the deleting of the file formed by the re-used blocks, these blocks are again soon re-used.

In other words, repeated cycles of the writing of a file, the deleting of the file, a power-down and power-on lead to a given block being repeatedly used many times, resulting in inconvenience for the flash memory limited in the number of writes.

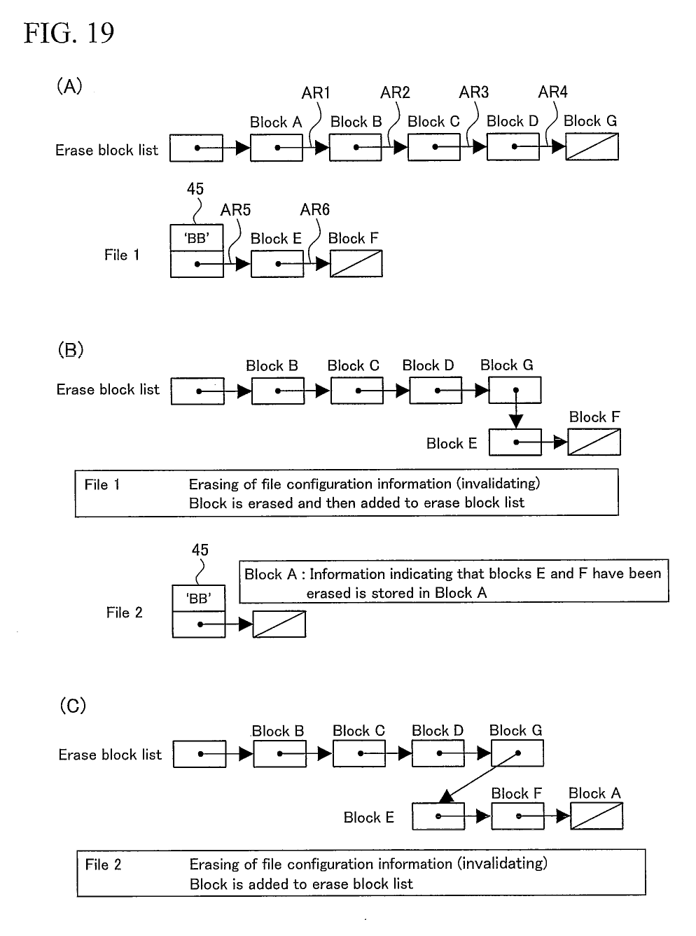

In the file system according to the second embodiment of the present invention, therefore, the deleting of a file is accomplished by writing a “file-delete-indicating file,” and the deleting of a previous file involves also erasing a block. Here, the file system is characterized in that the block ID of the block to be erased is appended also to the above-mentioned file. In other words, the deleting of a file is accomplished by writing a “delete-indicating file,” actually erasing a block used by the file to be deleted, and appending the block ID of the block to be actually erased to the “delete-indicating file.” Further, the erased block and the block that constitutes the “delete-indicating file” are linked, in this order, to the erase block list. Thereby, even in the event of a power-down before the re-use of the erased block, the erased block can be linked to the erase block list in an appropriate position, not to the free block list, at the next time of the mount processing. The reason is as follows: the block that constitutes the “delete-indicating file” is linked to the erase block list at the time of the mount processing, and thus, when there is such a block, information appended to the file about the erased block can be taken out and the erased block can be inserted immediately before that block thereby to reconfigure the erase block list at the time of a power-down. Specifically, as shown in FIG. 19(A), the configuration information before the deleting of a file is such that the blocks A, B, C, D and G are linked to the erase block list as indicated by the arrows AR1 to AR4. Also, the file 1 with the file name 45, ‘BB,’ is composed of the blocks E and F.

Here, as shown in FIG. 19(B), the configuration information during the deleting of the file is such that, when the file 1 is deleted, the blocks E and F that constitute the file 1 are linked to the erase block list, and a file 2 that is the “delete-indicating file,” composed of the block A, is newly generated. At this time, the block A is the beginning block of the erase block list, taken out of the erase block list. Further, the block A has information indicating that the blocks E and F have been erased, appended thereto. Thereafter, the blocks E and F are actually erased.

Finally, as shown in FIG. 19(C), the configuration information after the deleting of the file is such that the erase block list is in the form of the list shown in FIG. 19(B) having the block A added thereto.

The information indicating that the blocks E and F have been erased is stored in the block A, thus making it possible to reconstruct the erase block list even in the event of a power-down.

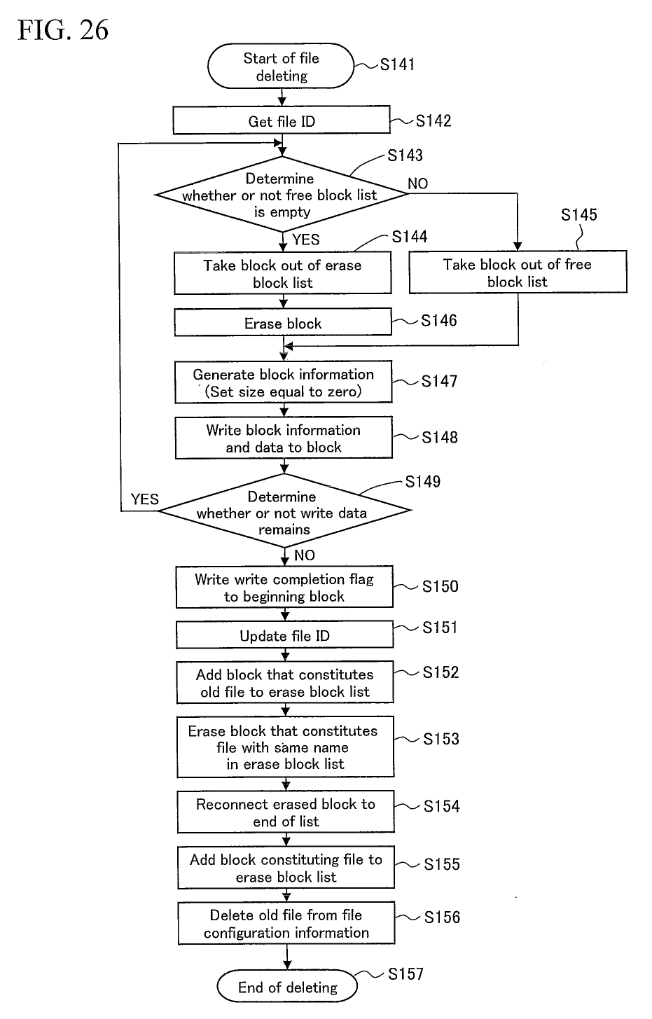

Description will be given with reference to FIG. 26 with regard to the procedure of the delete processing. First, the delete processing starts at step S141. Then, at step S142, a file ID is acquired. At step S143, a determination is made as to whether or not the free block list is empty. If the free block list is empty (YES), the process proceeds to step S144, at which a block is taken out of the erase block list, not out of the free block list. At step S146, the block is erased, and at step S147, block information is generated. At this time, the file size is set equal to zero. If the free block list is not empty at step S143 (NO), the process proceeds to step S145, at which a block is taken out of the free block list. The process proceeds to step S147, at which block information is generated. At this time, the file size is set equal to zero. Then, at step S148, the block information and data are written to the block. At this time, the block ID of the block to be actually erased is appended as the data. Then, at step S149, a determination is made as to whether or not write data remains. Then, at step S150, a write completion flag is written to the beginning block. At step S151, the file ID is updated. At step S152, blocks constituting the old file are added to the erase block list. At step S153, a block that constitutes a file with the same name in the erase block list is erased. At step S154, the erased block is re-linked to the end of the erase block list. At step S155, a block constituting the file is added to the erase block list. At step S156, the old file is deleted from the file configuration information, and the writing is brought to an end (at step S157).

Step S154 is executed to re-link the erased block to the erase block list (or add the erased block to the erase block list at the end thereof), and thereby, unless a power-down occurs, the erased blocks are not used until the blocks contained since the beginning in the erase block list are used up. On the other hand, in the event of a power-down during deleting, a procedure described below, at the time of the mount processing, can be performed to remove these blocks from the free block list and re-link the blocks to the erase block list and thereby to restore the erase block list to a state in which the power-down has occurred. This enables preventing one and the same block alone from being re-used many times, even if block erasing takes place at the time of file deleting.

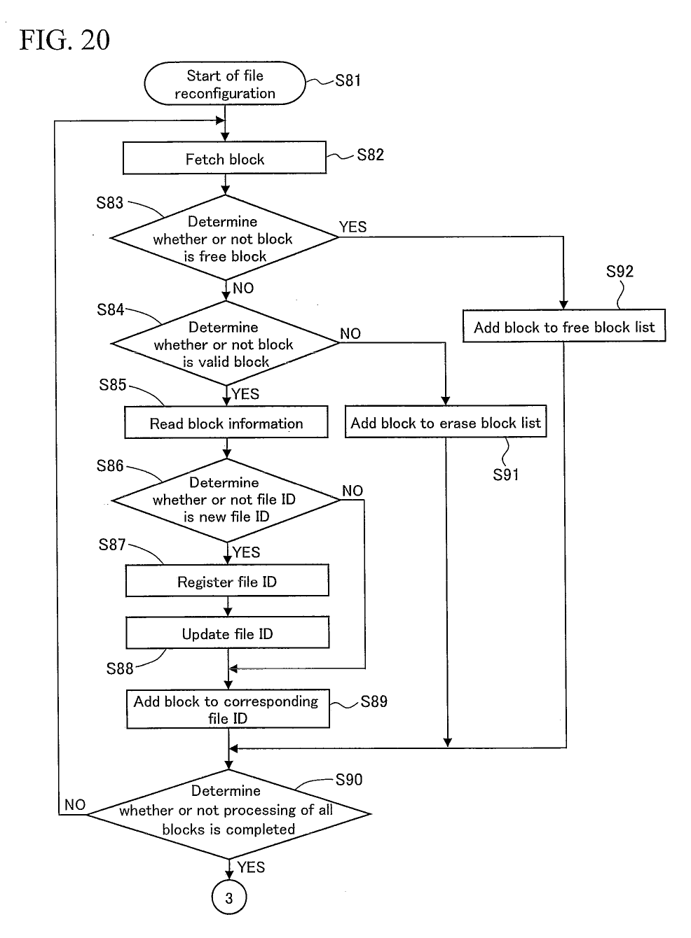

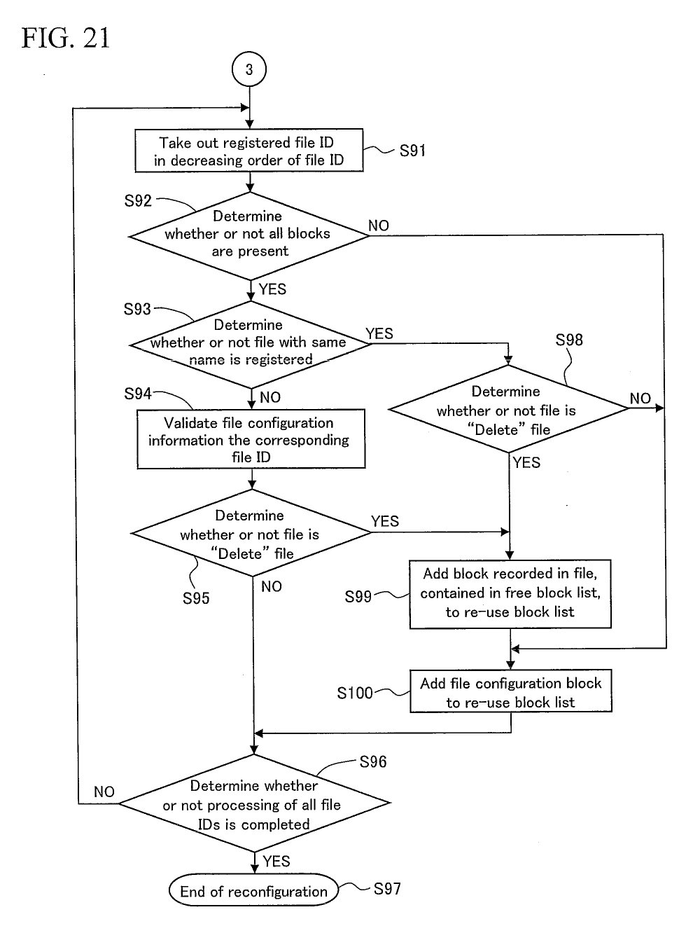

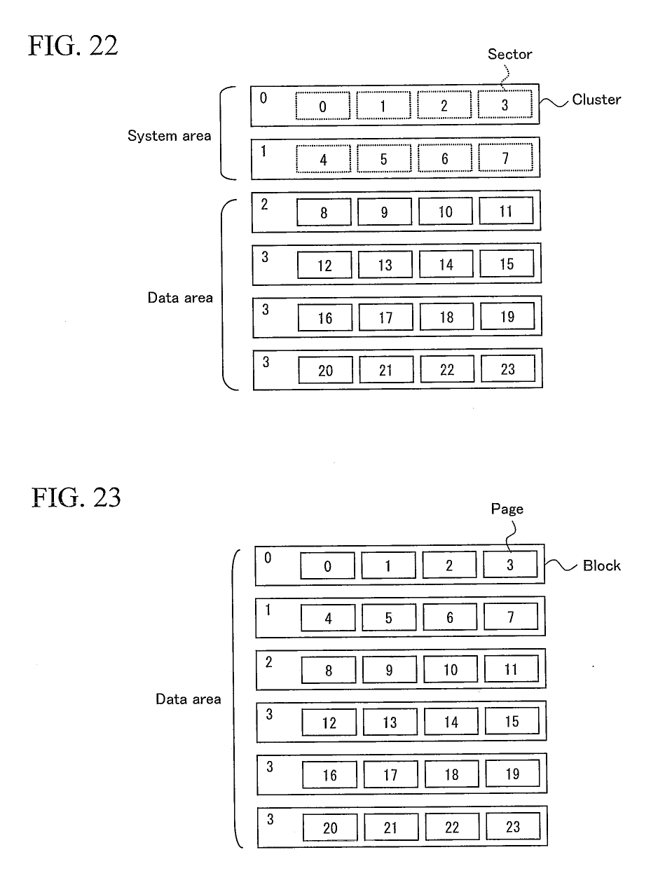

Description will now be given with reference to FIG. 20 with regard to the procedure of the mount processing. First, reconfiguration starts at step S81, and at step S82, a block is fetched. At step S83, a determination is made as to whether or not the block is a free block. If the block is a free block (YES), the process proceeds to step S92, at which the block is added to the free block list, and the process proceeds to step S90. If the block is not a free block (NO), at step S84 a determination is made as to whether the block is a valid block. If the block is a valid block (YES), the process proceeds to step S85. If the block is not a valid block (NO), at step S91 the block is added to the erase block list, and the process proceeds to step S90. At step S85, block information is read in, and at step S86, a determination is made as to whether or not the file ID in the block information is a new file ID. If the file ID is a new file ID, the file ID is registered at step S87, and the block is added to the corresponding file ID at step S88. Then, at step S90, a determination is made as to whether or not the processing of all blocks is completed. If the processing of all blocks is not completed (NO), the process returns to step S82. If the processing of all blocks is completed (YES), the process proceeds to steps of FIG. 21.

FIG. 21 is a flowchart showing the procedure of a processing following FIG. 20. If the processing of all blocks is completed at step S90 (YES), the process proceeds to step S91, at which the registered file ID is taken out in decreasing order of the file ID (that is, the order is from the most recently created one to the least recently created one). At step S92, a determination is made as to whether or not all blocks are present. If all blocks are not present (NO), the process proceeds to step S100, at which blocks constituting the file are added to the erase block list, and the process proceeds to step S96. If all blocks are present at step S92 (YES), at step S93 a determination is made as to whether or not a file with the same name is registered. If the file with the same name is not registered (NO), the process proceeds to step S94, at which the file configuration information of the corresponding file ID is validated. At step S95, a determination is made as to whether or not the file is the delete file. If the file is not the delete file (NO), the process proceeds to step S96. If the file with the same name is registered at step S93 (YES), the process proceeds to step S98, at which a determination is made as to whether or not the file is the delete file. If the file is not the delete file (NO), the process proceeds to step S100. If the file is the delete file (YES), the process proceeds to step S99 at which a block recorded in this file is taken out of the free block list and added to the erase block list, and the process proceeds to step S100. At step S96, a determination is made as to whether or not the processing of all IDs is completed. If the processing of all IDs is not completed (NO), the process returns to step S91. If the processing of all IDs is completed (YES), the reconfiguration processing is brought to an end at step S97.

Incidentally, the block added to the erase block list at step S100 is the block that constitutes the file in which all blocks are not present, coming from step S92; the block that constitutes the file in the case where although it is the proper file, the new file with the same name is present, coming from step S98; and the block that constitutes the latest delete file, coming from step S95. In other words, the block linked to the erase block list is the block other than the block that constitutes the valid file in which all blocks are present and which is not a delete file.

Assuming that the above is a basic form, an extension of this may be that in the above step S148, not only the block ID of the block to be erased but also the file ID and the block number of the block are appended to the “delete-indicating file”; also, in the above step S152, the block is linked to the erase block list in the order of the file ID and the block number; further, in the above step S154, after the erasing of the block, the block is not re-linked. In this instance, at the time of mounting after the occurrence of a power-down, when the erased block is removed from the free block list and re-linked to the erase block list, both the file ID retained in conjunction with the block number, and the block number may be used to re-link the block to the erase block list and thereby to likewise restore the erase block list to a state in which the power-down has occurred. This method has the merit that the block re-use order is perfectly the same as the order in a situation where block erasing does not take place during file deleting, and thus the order is easy to see, whereas this method has the demerit of making its implementation a little complicated.

In any of the basic form and the extension thereof, a situation does not arise where one and the same block alone is re-used many times, and thus, any of these methods may be selected according to the purpose.

As described above, the file system according to the second embodiment of the present invention enables high-speed file processing. Also, the file system enables wear leveling. Further, the file system has the advantage of making it possible to reconfigure file information and thus preventing a file from being damaged or destroyed, even in the event of a power-down during file writing. Also, the file system has the advantage of actually erasing data for file deleting and thus ensuring security.

### INDUSTRIAL APPLICABILITY

The present invention is applicable to a file system for flash memory for use in electronic equipment.

1. A file system on a memory in which a memory area is composed of blocks, the erasing of data written in the memory area takes place block by block, each of the blocks is composed of a plurality of pages, and the writing of data to the memory area takes place page by page, characterized by comprising:
a block information appending means for appending block information that is file configuration information, to each of the blocks; and
a file configuration information reconstruction means for reconstructing the file configuration information based on the block information.

2. The file system according to claim 1, characterized by comprising a magic number appending means for appending a magic number, when appending the block information.

3. The file system according to claim 2, characterized by comprising a block check means for checking the validity of each of the blocks, based on whether or not the magic number is appended to the beginning page and the last used page of each block.

4. The file system according to claim 2, characterized by comprising a page verifying means for writing data sequentially from the beginning page of each block and for verifying data every time the data is written in the page.

5. The file system according to claim 2, characterized in that the block is provided with at least first and second magic number areas before and after a data area in which data is to be written, the magic number areas each being used to write the magic number therein.

6. The file system according to claim 5, characterized in that an area in which the block information is to be written is provided ahead of the first magic number area.

7. A memory in which a memory area is composed of at least one block, the erasing of data written in the memory area takes place block by block, each of the blocks is composed of a plurality of pages, and the writing of data to the memory area takes place page by page, characterized by comprising:
a block information appending means for appending block information that is file configuration information, to each of the blocks; and
a file configuration information reconstruction means for reconstructing the file configuration information, based on the block information.

8. The memory according to claim 7, characterized by comprising a magic number appending means for appending a magic number, when appending the block information.

9. The memory according to claim 8, characterized by comprising a block check means for checking the validity of each of the blocks, based on whether or not the magic number is appended to the beginning page and the last used page of each block.

10. The memory according to claim 8, characterized by comprising a page verifying means for writing data in turn from the beginning page of each block and for verifying data every time the data is written in the page.

11. The file system according to claim 10, characterized in that the block is provided with at least first and second magic number areas before and after a data area in which data is to be written, the magic number areas each being used to write the magic number therein.

12. The memory according to claim 11, characterized in that an area in which the block information is to be written is provided ahead of the first magic number area.

13. Electronic equipment, characterized by comprising the file system according to claim 1.

14. Electronic equipment, characterized by comprising the memory according to claim 7.

15. A file configuration information reconstruction method for use in a memory in which a memory area is composed of blocks, the erasing of data written in the memory area takes place block by block, each of the blocks is composed of a plurality of pages, and the writing of data to the memory area takes place page by page, characterized by comprising the steps of:
appending block information that is file configuration information, to each of the blocks; and
reconstructing the file configuration information, based on the block information.

16. The file configuration information reconstruction method according to claim 15, characterized by comprising the step of appending a magic number, when appending the block information.

17. A file system on a memory in which a memory area is composed of blocks, the erasing of data written in the memory area takes place block by block, each of the blocks is composed of a plurality of pages, and the writing of data to the memory area takes place page by page, characterized by comprising:
a completion flag writing means for writing a write completion flag indicative of the completion of writing in any of the blocks in a file, at the completion of the writing of the file; and
a completion flag reading means for reading out the write completion flag.

18. The file system according to claim 17, characterized in that the write completion flag is written in the beginning block in the file.

19. The file system according to claim 17, characterized in that the write completion flag is written in the last page of the block.

20. The file system according to claim 17, characterized by further comprising:
a block information appending means for appending block information that is file configuration information, to the block; and
a file configuration information reconstruction means for reconstructing the file configuration information indicative of a file configuration, based on the block information.

21. A file system on a memory in which a memory area is composed of blocks, the erasing of data written in the memory area takes place block by block, each of the blocks is composed of a plurality of pages, and the writing of data to the memory area takes place page by page, characterized by comprising a file updating means for invalidating an old file with the same name, at the completion of the writing of a file.

22. A file writing method for writing a file to a memory in which a memory area is composed of blocks, the erasing of data written in the memory area takes place block by block, each of the blocks is composed of a plurality of pages, and the writing of data to the memory area takes place page by page, characterized by comprising the step of writing a write completion flag into a block in a file, at the completion of the writing of the entire file.

23. A file updating method for updating a file on a memory in which a memory area is composed of blocks, the erasing of data written in the memory area takes place block by block, each of the blocks is composed of a plurality of pages, and the writing of data to the memory area takes place page by page, characterized by comprising the steps of:
generating a file with the same name as that of a target file to be updated;
updating the file with the same name as that of the target file; and
invalidating the target file at the completion of updating.

24. A memory in which a memory area is composed of blocks, the erasing of data written in the memory area takes place block by block, each of the blocks is composed of a plurality of pages, and the writing of data to the memory area takes place page by page, characterized by comprising:
a completion flag writing means for writing a write completion flag indicative of the write completion into a block in which data is written, at the completion of the writing of the file; and
a completion flag reading means for reading out the write completion flag.

25. The memory according to claim 24, characterized in that the write completion flag is written in the beginning block of the blocks in which the data is written.

26. The memory according to claim 24, characterized in that the write completion flag is written in the last page of the block.

27. A file system on a memory in which a memory area is composed of blocks, the erasing of data written in the memory area takes place block by block, each of the blocks is composed of a plurality of pages, and the writing of data to the memory area takes place page by page, the file system comprising:
a file ID assignment means for assigning a file ID not assigned to any file, to a file, at the time of the writing of the file; and
a file updating means for invalidating an old file with the same name, at the completion of the writing of the file,
the file system being characterized in that the deleting of the file is performed by newly writing a delete file indicative of deleting.

28. The file system according to claim 27, comprising a file writing order determining means for determining the file writing order based on the file ID,
the file system being characterized in that the blocks which constitute the invalidated old file are linked to each other in an erase block list based on the file writing order, and,
at the time of the writing of the file, the blocks linked in the erase block list are taken out and re-used, starting from the earliest written one, based on the file writing order.

29. A file deleting method for deleting a file on a memory in which a memory area is composed of blocks, the erasing of data written in the memory area takes place block by block, each of the blocks is composed of a plurality of pages, and the writing of data to the memory area takes place page by page, characterized by comprising the steps of:
assigning a file ID not assigned to any file, to a file, at the time of the writing of the file;
invalidating an old file with the same name, at the completion of the writing of the file; and
deleting the file by newly writing a delete file indicative of deleting.

30. The file deleting method according to claim 29, characterized by comprising the steps of:
determining the file writing order based on the file ID, and
linking the blocks to each other in an erase block list on the basis of the file writing order, the blocks each constituting the invalidated old file, and, at the time of the writing of the file, taking out and re-using the blocks linked in the erase block list, starting from the earliest written one based on the file writing order.

31. A memory in which a memory area is composed of blocks, the erasing of data written in the memory area takes place block by block, each of the blocks is composed of a plurality of pages, and the writing of data to the memory area takes place page by page, the memory comprising:
a file ID assignment means for assigning a file ID not assigned to any file, to a file, at the time of the writing of the file; and
a file updating means for invalidating an old file with the same name, at the completion of the writing of the file,
the memory being characterized in that the deleting of the file is performed by newly writing a delete file indicative of deleting.

32. The memory according to claim 31, comprising a file writing order determining means for determining the file writing order based on the file ID,
the memory being characterized in that the blocks which constitute the invalidated old file are linked to each other in an erase block list based on the file writing order, and, at the time of the writing of the file, the blocks linked in the erase block list are taken out and re-used, starting from the earliest written one based on the file writing order.

33. The memory according to claim 32, characterized in that the delete file has the same file name as that of the file to be deleted.

34. The memory according to claim 33, characterized in that the delete file is left at least until all blocks that constitute the file to be deleted are re-used.

35. The memory according to claim 34, characterized in that the delete file includes information about the blocks that constitute the file to be deleted, and information about the blocks that constitute the file with the same name linked to the erase block list, in the form of data.

36. The memory according to claim 35, characterized in that, after the writing of the delete file, a processing for erasing the blocks that constitute the file with the same name linked to the erase block list is performed.

37. The memory according to claim 36, characterized in that, at the time of reconfiguration of the erase block list, the block that constitutes the delete file is added to the erase block list, and the block recorded in data in the delete file is added immediately before that block.

38. The memory according to claim 36, characterized in that, at the time of reconfiguration of the erase block list, the block that constitutes the delete file is added to the erase block list, and the block recorded in the data in the delete file is inserted into the erase block list in an appropriate position, based on the information.

39. The memory according to claim 31, characterized in that a value that is larger than the previously assigned highest file ID number by one is assigned as a file ID not assigned to any file.
